(19) United States
(12) Patent Application Publication
(10) Pub. No.: US 2025/0008391 A1
(43) Pub. Date: Jan. 2, 2025

(54) IMPROVEMENTS IN AND RELATING TO L1/L2 TRIGGERED MOBILITY IN A TELECOMMUNICATIONS NETWORK

(71) Applicant: Samsung Electronics Co., Ltd., Suwon-si, Gyeonggi-do (KR)

(72) Inventor: Donggun KIM, Staines (GB)

(21) Appl. No.: 18/755,095

(22) Filed: Jun. 26, 2024

(30) Foreign Application Priority Data
Jun. 29, 2023 (GB) 2309907.0
May 29, 2024 (GB) 2407603.6

(51) Int. Cl. H04W 36/00; H04W 56/00; H04W 76/19; H04W 76/20; H04W 80/02

(52) U.S. Cl. CPC H04W 36/00725; H04W 56/0045; H04W 76/19; H04W 76/20; H04W 80/02

(57) ABSTRACT

A method performed by a terminal in a wireless communication system is provided. The method includes receiving, from a base station, a radio resource control (RRC) message including layer 1 (L1)/layer 2 (L2) triggered mobility (LTM) configuration information, the LTM configuration information including at least one LTM candidate configuration for at least one candidate cell, transmitting, to the base station, a report for an L1 measurement on the at least one candidate cell, receiving, from the base station via a medium access control (MAC) control element (CE), an LTM cell switch command based on the report, identifying whether a value of a timing advance command (TAC) in the MAC CE is set to a specific value, and in case that the value of the TAC is not set to the specific value, processing the TAC and performing a random access channel (RACH)-less LTM cell switch for a target cell identified by the MAC CE.

### CROSS-REFERENCE TO RELATED APPLICATION(S)

This application is based on and claims priority under 35 U.S.C. § 119 (a) of a United Kingdom patent application number 2309907.0, filed on Jun. 29, 2023, in the United Kingdom Intellectual Property Office, and of a United Kingdom patent application number 2407603.6, filed on May 29, 2024, in the United Kingdom Intellectual Property Office, the disclosure of each of which is incorporated by reference herein in its entirety.

### BACKGROUND

### 1. Field

The disclosure relates to a method and apparatus for supporting layer 1 (L1)/layer 2 (L2)-Triggered Mobility (LTM) in a wireless communication system.

### 2. Description of Related Art

5th generation (5G) mobile communication technologies define broad frequency bands such that high transmission rates and new services are possible, and can be implemented not only in “Sub 6 gigahertz (GHz)” bands such as 3.5 GHZ, but also in “Above 6 GHz” bands referred to as millimeter wave (mmWave) including 28 GHz and 39 GHz. In addition, it has been considered to implement 6th generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra-reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting various numerologies (for example, operating a plurality of subcarrier spacings, etc.) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large scale antennas, metamaterial-based lenses and antennas for improving coverage of terahertz band signals, high-dimensional space multiplexing technology using orbital angular momentum (OAM), and reconfigurable intelligent surface (RIS), but also full duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of terminal operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for supporting L1/L2-Triggered Mobility (LTM) with low latency, low complexity and no user plane data loss. It also relates to legacy behaviors in order to address possible issues where a new LTM cell switch feature could possibly conflict with them.

Certain definitions and terms are used throughout this application. These include:
Physical downlink control channel (PDCCH) occasion: A time duration (i.e. one or a consecutive number of symbols) during which the medium access control (MAC) entity is configured to monitor the PDCCH.
Serving Cell: A primary cell (PCell), a primary secondary cell (PSCell), or a secondary cell (SCell).
Special Cell (SpCell): For Dual Connectivity operation the term Special Cell refers to the PCell of the master cell group (MCG) or the PSCell of the secondary cell group (SCG) depending on if the MAC entity is associated to the MCG or the SCG, respectively. Otherwise the term Special Cell refers to the PCell. A Special Cell supports PUCCH transmission and contention-based Random Access, and is always activated.
Timing Advance Group: A group of Serving Cells that is configured by radio resource control (RRC) and that, for the cells with a UL configured, using the same timing reference cell and the same Timing Advance value. A Timing Advance Group containing the SpCell of a MAC entity is referred to as Primary Timing Advance Group (PTAG), whereas the term Secondary Timing Advance Group (STAG) refers to other TAGs.
Msg3: Message transmitted on UL-SCH containing a cell radio network temporary identifier (C-RNTI) MAC control element (CE) or common control channel (CCCH) service data unit (SDU), submitted from upper layer and associated with the UE Contention Resolution Identity, as part of a Random Access procedure.
LTM candidate cell: A candidate cell configured to the UE as specified by LTM candidate cell configuration (i.e. LTM-CandidateConfig) for LTM in RRC layer.

The term “cell switch” is used herein for the procedure of triggering change of cells via the LTM feature and use the term “Subsequent LTM” for the case when cell switch between L1/L2 mobility candidates is done without RRC reconfiguration in between.

It is an aim of embodiments of the disclosure to address shortcomings in the prior art, whether mentioned herein or not.

Additional aspects will be set forth in part in the description which follows and, in part, will be apparent from the description, or may be learned by practice of the presented embodiments.

In accordance with an aspect of the disclosure, a method performed by a terminal in a wireless communication system is provided. The method includes receiving, from a base station, a radio resource control (RRC) message including layer 1 (L1)/layer 2 (L2) triggered mobility (LTM) configuration information, the LTM configuration information including at least one LTM candidate configuration for at least one candidate cell, transmitting, to the base station, a report for an L1 measurement on the at least one candidate cell, receiving, from the base station via a medium access control (MAC) control element (CE), an LTM cell switch command based on the report, identifying whether a value of a timing advance command (TAC) in the MAC CE is set to a specific value, and in case that the value of the TAC is not set to the specific value, processing the TAC and performing a random access channel (RACH)-less LTM cell switch for a target cell identified by the MAC CE.

In accordance with an aspect of the disclosure, a terminal in a wireless communication system is provided. The terminal includes a transceiver, and a controller coupled with the transceiver and configured to control the transceiver to receive, from a base station, a radio resource control (RRC) message including layer 1 (L1)/layer 2 (L2) triggered mobility (LTM) configuration information, the LTM configuration information including at least one LTM candidate configuration for at least one candidate cell, control the transceiver to transmit, to the base station, a report for an L1 measurement on the at least one candidate cell, control the transceiver to receive, from the base station via a medium access control (MAC) control element (CE), an LTM cell switch command based on the report, identify whether a value of a timing advance command (TAC) in the MAC CE is set to a specific value, and in case that the value of the TAC is not set to the specific value, process the TAC and perform a random access channel (RACH)-less LTM cell switch for a target cell identified by the MAC CE.

In accordance with an aspect of the disclosure, a method performed by a base station in a wireless communication system is provided. The method includes transmitting, to a terminal, a radio resource control (RRC) message including layer 1 (L1)/layer 2 (L2) triggered mobility (LTM) configuration information, the LTM configuration information including at least one LTM candidate configuration for at least one candidate cell, receiving, from the terminal, a report for an L1 measurement on the at least one candidate cell, and transmitting, to a terminal, a medium access control (MAC) control element (CE) including an LTM cell switch command based on the report, wherein the MAC CE includes a value of a timing advance command (TAC), and wherein the value of the TAC is used for performing a random access channel (RACH)-less LTM cell switch for a target cell identified by the MAC CE based on processing of the TAC in case that the value of the TAC is not set to a specific value.

In accordance with an aspect of the disclosure, a base station in a wireless communication system is provided. The base station includes a transceiver, and a controller coupled with the transceiver and configured to control the transceiver to transmit, to a terminal, a radio resource control (RRC) message including layer 1 (L1)/layer 2 (L2) triggered mobility (LTM) configuration information, the LTM configuration information including at least one LTM candidate configuration for at least one candidate cell, control the transceiver to receive, from the terminal, a report for an L1 measurement on the at least one candidate cell, and control the transceiver to transmit, to a terminal, a medium access control (MAC) control element (CE) including an LTM cell switch command based on the report, wherein the MAC CE includes a value of a timing advance command (TAC), and wherein the value of the TAC is used for performing a random access channel (RACH)-less LTM cell switch for a target cell identified by the MAC CE based on processing of the TAC in case that the value of the TAC is not set to a specific value.

In an embodiment, a value associated with the TAC is used to control a timing adjustment so that the UE skips a Random Access procedure for the LTM cell switch.

In an embodiment, if the value associated with the TAC is a particular predefined value then this indicates that no valid timing adjustment is available.

In an embodiment, LTM cell changes are triggered by MAC CE, and the procedure for defining a Special value because the TAC field always exists as Mandatory in MAC CE, and determining that a valid TAC value can be passed only if it is not that value, and skipping the RACH

In accordance with another aspect of the disclosure, cell changes are directed to MAC CE to reuse the T304 timer when performing LTM procedures, to suggest conditions for starting and stopping the timer, and to perform different actions for MCG and SCG when the timer expires.

In accordance with another aspect of the disclosure, layer 3 (L3) handover instruction are possible even if LTM is set due to network implementation limitations, but at the same time, LTM and L3 handover are restricted to prevent terminal implementation complexity. Even if LTM cell changes, SCell is enabled, and disabling is allowed as a setting.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages, of certain embodiments of the disclosure will be more apparent from the following description taken in conjunction with the accompanying drawings, in which:

FIG. 1 illustrates a signalling procedure for LTM according to an embodiment of the disclosure;

FIG. 2 illustrates a UE state machine showing state transitions in NR according to an embodiment of the disclosure;

FIG. 3 illustrates the structure of a long term evolution (LTE) system to which an embodiment may be applied according to an embodiment of the disclosure;

FIG. 4 illustrates a radio protocol structure in an LTE system to which an embodiment may be applied according to an embodiment of the disclosure;

FIG. 5 illustrates the structure of a next generation system to which an embodiment may be applied according to an embodiment of the disclosure;

FIG. 6 illustrates a radio protocol structure of a next-generation mobile communication system according to an embodiment of the disclosure;

FIG. 7 illustrates RRC a successful reconfiguration according to an embodiment of the disclosure;

FIG. 8 illustrates an RRC reconfiguration failure according to an embodiment of the disclosure;

FIG. 9 illustrates SCell Activation/Deactivation MAC CE of one octet according to an embodiment of the disclosure;

FIG. 10 illustrates SCell Activation/Deactivation MAC CE of four octets according to an embodiment of the disclosure;

FIG. 11 illustrates Enhanced SCell Activation/Deactivation MAC CE with one octet Ci field according to an embodiment of the disclosure;

FIG. 12 illustrates Enhanced SCell Activation/Deactivation MAC CE with four octet Ci field according to an embodiment of the disclosure;

FIG. 13 illustrates an example of a downlink (DL) MAC protocol data unit (PDU) according to an embodiment of the disclosure;

FIG. 14 illustrates an example of a UL MAC PDU according to an embodiment of the disclosure; and

FIG. 15 illustrates a flowchart according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

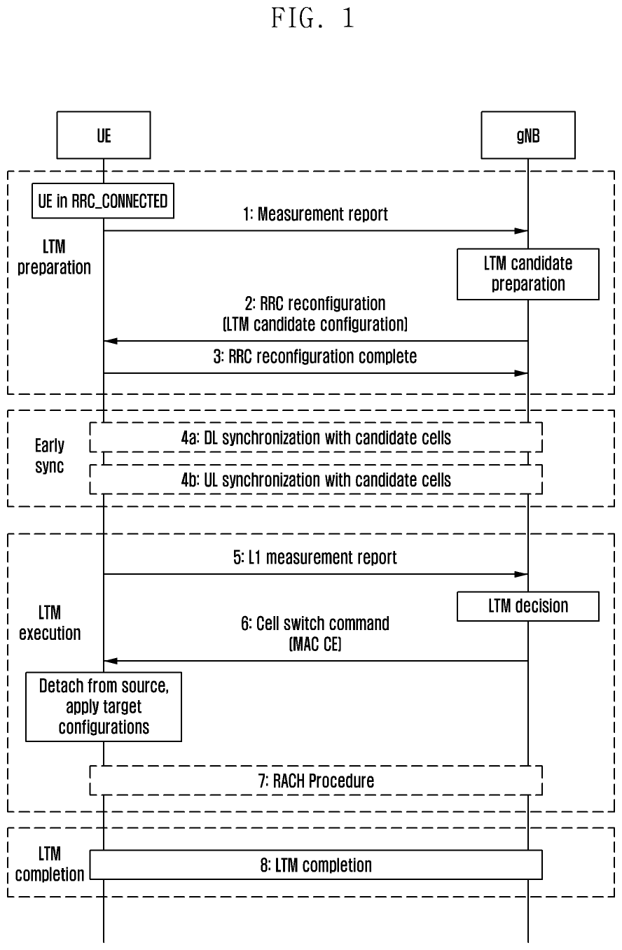

FIGS. 1 to 15, discussed below, and the various embodiments used to describe the principles of the disclosure in this patent document are by way of illustration only and should not be construed in any way to limit the scope of the disclosure. Those skilled in the art will understand that the principles of the disclosure may be implemented in any suitably arranged system or device.

Hereinafter, preferred embodiments of the disclosure will be described in detail with reference to the accompanying drawings. In this case, it should be noted that in the accompanying drawings, the same components are denoted by the same reference numerals as much as possible. In addition, detailed descriptions of well-known functions and configurations that may obscure the gist of the disclosure will be omitted.

In describing the embodiments of the specification, descriptions of technical contents that are well known in the technical field to which the disclosure belongs and are not directly related to the disclosure will be omitted. This is to more clearly convey the gist of the disclosure by omitting unnecessary description.

For the same reason, some components are exaggerated, omitted, or schematically illustrated in the accompanying drawings. In addition, the size of each component does not fully reflect the actual size. In each figure, the same or corresponding elements are assigned the same reference numerals.

Advantages and features of the disclosure and methods of accomplishing the same may be understood more readily by with reference to the following detailed description of the embodiments of the disclosure and the accompanying drawings. The disclosure may, however, be embodied in many different forms and should not be construed as limited to embodiments set forth herein; rather these embodiments are provided so that this disclosure will be thorough and complete, and will fully convey the scope of the disclosure only defined by the claims to one of ordinary skill in the art. The same reference numerals refer to the same elements throughout the disclosure.

In this case, it will be understood that each block of process flowcharts and combinations of the flowcharts may be performed by computer program instructions. Because these computer program instructions may be embedded in a processor of a general-purpose computer, a special-purpose computer, or other programmable data processing apparatuses, the instructions executed through the processor of the computer or other programmable data processing apparatus generates means for performing the functions described in the flowchart block(s). Because these computer program instructions may also be stored in a computer-executable or computer-readable memory that may direct the computer or other programmable data processing apparatus so as to implement functions in a particular manner, the instructions stored in the computer-executable or computer-readable memory are also capable of producing an article of manufacture containing instruction modules for performing the functions described in the flowchart block(s). Because the computer program instructions may also be embedded into the computer or other programmable data processing apparatus, the instructions for executing the computer or other programmable data processing apparatuses by generating a computer-implemented process by performing a series of operations on the computer or other programmable data processing apparatuses may provide operations for executing the functions described in the flowchart block(s).

Also, each block may represent part of a module, segment, or code that includes one or more executable instructions for executing a specified logical function(s). It should also be noted that, in some alternative implementations, the functions described in the blocks may occur out of the order noted in the drawings. For example, two blocks illustrated in succession may in fact be executed substantially concurrently, or the blocks may sometimes be executed in a reverse order, depending on the corresponding functions involved therein.

In this case, as used herein, the “unit” refers to a software element or a hardware element, such as Field Programmable Gate Array (FPGA) or Application Specific Integrated Circuit (ASIC), which performs a predetermined function. However, the “unit” does not always have a meaning limited to software or hardware. The “unit” may be constructed either to be stored in an addressable storage medium or to execute one or more processors. Thus, a “unit” may include, by way of example, components, such as software components, object-oriented software components, class components, and task components, processes, functions, attributes, procedures, subroutines, segments of program code, drivers, firmware, microcode, circuitry, data, databases, data structures, tables, arrays, and variables. The functionality provided in the components and “units” may be combined into fewer components and “units” or may be further separated into additional components and “units.” Further, the components and “units” may be implemented to operate one or more CPUs in a device or a secure multimedia card.

The detailed description of embodiments of the disclosure is made mainly on the basis of a new radio (NR) access network and packet core (a 5G system, a 5G core network, or a next generation (NG) core) which is a core network on the 5G mobile communication standard specified by the 3rd generation partnership project (3GPP), which is a mobile communication standardization organization, but the main subject of the disclosure can be applied to other communication systems having a similar technical background with slight modification without departing from the scope of the disclosure, which can be determined by those skilled in the art.

In the 5G system, a network data collection and analysis function (NWDAF) that is a network function for analyzing and providing data collected by a 5G network may be defined to support network automation. The NWDAF may collect information from the 5G network, store and analyze the information, and provide the result to an unspecified network function (NF), and the analysis result may be independently used by each NF.

For convenience of explanation, the disclosure will hereinafter use terms and names defined by the 3rd generation partnership project long term evolution (3GPP) standards (standards of 5G, NR, LTE, or similar systems). However, the disclosure is not limited by the terms and names and may be equally applied to systems conforming to other standards.

In the following description, terms with reference to a signal, terms with reference to a channel, terms with reference to control information, terms with reference to network entities, and terms with reference to elements of a device are used for convenience of description. Accordingly, the disclosure is not limited to those terms, and other terms having the same technical meanings may be used.

Hereinafter, a base station refers to an entity for allocating resources to a terminal and may be at least one of a gNode B (gNB), an eNode B (eNB), a node B, a base station (BS), a radio access unit, a base station controller, and a node over a network. A terminal may include a user equipment (UE), a mobile station (MS), a cellular phone, a smartphone, a computer, or a multimedia system capable of performing a communication function. However, this is only an example, and the base station and terminal are not limited to the examples described above. In the disclosure, an eNB may be interchangeably used with a gNB for convenience of descriptions. That is, a BS described by an eNB may represent a gNB. In the disclosure, the term “terminals” may refer to not only cellular phones, NB-IoT devices, and sensors, but also various wireless communication devices.

In the following description, the terms of physical channel and signal may be interchangeably used with data or a control signal. For example, a physical downlink shared channel (PDSCH) is a term with reference to a physical channel on which data is transmitted. However, the PDSCH may also be used to refer to data. In other words, in the disclosure, the expression “transmit a physical channel” may be interpreted as being equivalent to the expression “transmit data or a signal on a physical channel.”

Hereinafter, in the disclosure, higher layer signaling denotes a signal transfer scheme in which a signal is transferred to a terminal from a base station by using a downlink data channel at a physical layer, or in which a signal is transferred to a base station from a terminal by using an uplink data channel at a physical layer. The higher layer signaling may be understood as radio resource control (RRC) signaling or a media access control (MAC) control element (CE).

In addition, in the disclosure, to determine whether a specific condition is satisfied or fulfilled, the expression of exceeding or less than has been used, but this is merely an example, and does not exclude a statement of equal to or more than or equal to or less than. A condition stated as “equal to or more than” may be replaced with “exceeding,” and a condition stated as “equal to or less than” may be replaced with “less than,” and a condition stated “as equal to or more than and less than” may be replaced with “exceeding and equal to or less than.”

In addition, the disclosure describes an embodiment by using terms used in some communication standards (e.g., a 3rd generation partnership project (3GPP)), but this is merely an example. An embodiment of the disclosure may easily be modified and applied to other communication systems.

The following describes certain principles for L1/L2-Triggered Mobility (LTM).

LTM is a procedure in which a gNB receives L1 measurement reports from UEs, and on their basis the gNB changes UEs' serving cell(s) by a cell switch command through a MAC CE, which indicates an LTM candidate cell configuration that the gNB previously prepared and provided to the UE through RRC signalling. Then cell switch is triggered, by selecting the indicated LTM candidate cell configuration as the target configuration by the gNB. An LTM candidate cell configuration can only be added, modified and released by network via RRC signaling. The LTM procedure can be used to reduce the mobility.

Network may request the UE to perform early TA acquisition (or TA acquisition) of a candidate cell (i.e. LTM candidate cell) before a cell switch. The early TA acquisition (or TA acquisition) is triggered by physical downlink control channel (PDCCH) order or through UE-based TA measurement.

The network indicates in the cell switch command whether the UE shall access the target cell with a Random Access (RA) procedure or with physical uplink shared channel (PUSCH) transmission using the indicated TA value. For RACH-less LTM, the UE either monitors PDCCH for dynamic scheduling from the target cell upon LTM cell switch, or the UE selects the configured grant occasion associated with the beam indicated in the cell switch command (e.g. the first MAC CE or RRC configuration).

The following principles apply to LTM:
Each LTM candidate cell configuration can be provided as delta configuration on top of a reference configuration, which is used to form a complete candidate cell configuration. The reference configuration can be managed separately, and a UE stores the reference configuration as a separate configuration. The LTM candidate cell configuration can be configured in RRCReconfiguration message via SRB1 (e.g. Signaling Radio Bearer), i.e. it can be configured after SRB1 establishment.
When a complete candidate cell configuration is applied, it replaces the current UE configuration at the time of cell switch. Although the reconfiguration procedure makes replacement, it doesn't necessarily reset MAC, radio link control (RLC) or packet data convergence protocol (PDCP) layer.
User plane is continued without reset to support lossless delivery of user plane data (e.g. intra-DU LTM), if it is configured in RRC signaling, with the target to avoid data loss and the additional delay of data recovery. Specifically, indicators for RLC re-establishment or MAC reset (or Partial MAC reset) or PDCP re-establishment or PDCP data recovery or SDU discard can be included in RRCReconfiguration message as listed below, which can be included with LTM candidate cell configuration together:
   an indicator for MAC reset or Partial MAC reset included in RRCReconfiguration message (e.g. in Cell group (or Cell) configuration)
   an indicator for RLC re-establishment (e.g. reestablishRLC) included in RRCReconfiguration message (e.g. in Cell group (or Cell) configuration)
   an indicator for PDCP re-establishment (e.g. reestablishPDCP) included in RRCReconfiguration message (e.g. in radio bearer configuration, i.e. RadioBearerConfig information element (IE))
   an indicator for PDCP data recovery (e.g. recoverPDCP) included in RRCReconfiguration message (e.g. in radio bearer configuration, i.e. RadioBearerConfig IE)
   an indicator for SDU discard (e.g. discardOnPDCP) for SRBs (e.g. SRB1 or SRB3) included in RRCReconfiguration message (e.g. in radio bearer configuration, i.e. RadioBearerConfig IE), which can be called PDCP SDU discard.
   The above indicators can be included in RRCReconfiguration message (e.g. in Cell group configuration or LTM candidate cell configuration) including candidate cell configurations for LTM. Upon the reception of the RRCReconfiguration message, UE can store the cell configuration and the indicators and does not apply them to UE configuration. When UE successfully completes it after triggering the LTM procedure (or cell switch) by a cell switch command through a MAC CE indicating the target cell(s) (e.g. identifier(s)), beam index, or, Timing Advance (TA) value, UE can apply the LTM candidate cell configuration and the indicators corresponding to the target cell (or indicated cell in MAC CE). The following conditions are considered as successful completion of the LTM procedure (i.e. cell switch):
   For RACH-based LTM procedure (cell switch), the UE considers that LTM execution procedure is successfully completed when the RACH is successfully completed.
   For RACH-less LTM procedure (cell switch), the UE considers that LTM execution procedure is successfully complete when the UE determines the NW has successfully received its first UL data.
   When the above condition for successful completion of LTM cell switch is met (or the LTM cell candidate configuration is complete, i.e. if the LTM cell candidate configuration is indicated to be applied by an indicator), UE can apply the LTM candidate cell configuration and the indicators corresponding to the target cell (or indicated cell in MAC CE) to UE configuration. This approach can avoid UE's early application and reverting it back when it fails, which eases UE implementation. Moreover, the UE cannot know the time when the network sends MAC CE indicating LTM cell switch to UE.
   For example, when the above condition is met, UE performs MAC reset (or partial MAC reset) if the indicator is configured in the stored configuration (e.g. LTM candidate cell configuration for LTM) corresponding to the target cell (or indicated cell in MAC CE or successfully switched cell), which can be done by applying the complete LTM cell configuration. When the condition is met, the MAC layer can indicate the successful completion of LTM cell switch to the RRC layer. The RRC layer can indicate MAC reset (or partial MAC reset) to MAC layer, if configured.
   For example, when the above condition is met, UE performs RLC re-establishment if the indicator is configured in the stored configuration (e.g. LTM candidate cell configuration for LTM) corresponding to the target cell (or indicated cell in MAC CE or successfully switched cell), which can be done by applying the complete LTM cell configuration. When the condition is met, the MAC layer can indicate the successful completion of LTM cell switch to the RRC layer. The RRC layer can indicate RLC re-establishment to RLC layer, if configured.
   For example, when the above condition is met, UE performs PDCP re-establishment if the indicator is configured in the stored configuration (e.g. LTM candidate cell configuration for LTM) corresponding to the target cell (or indicated cell in MAC CE or successfully switched cell), which can be done by applying the complete LTM cell configuration. When the condition is met, the MAC layer can indicate the successful completion of LTM cell switch to the RRC layer. The RRC layer can indicate PDCP re-establishment to PDCP layer, if configured.
   For example, when the above condition is met, UE performs PDCP data recovery if the indicator is configured in the stored configuration (e.g. LTM candidate cell configuration for LTM) corresponding to the target cell (or indicated cell in MAC CE or successfully switched cell), which can be done by applying the complete LTM cell configuration. PDCP data recovery can be configured only for a PDCP entity associated with AM RLC entities (RLC entity with Acknowledged Mode (AM) mode). When the condition is met, the MAC layer can indicate the successful completion of LTM cell switch to the RRC layer. The RRC layer can indicate PDCP data recovery to PDCP layer, if configured.
   For example, when the above condition is met, UE performs SDU discard in PDCP entity (i.e. PDCP SDU discard) if the indicator is configured in the stored configuration (e.g. LTM candidate cell configuration for LTM) corresponding to the target cell (or indicated cell in MAC CE or successfully switched cell), which can be done by applying the complete LTM cell configuration. SDU discard can be configured only for a PDCP entity of SRBs associated with AM RLC entities (RLC entity with Acknowledged Mode (AM) mode). When the condition is met, the MAC layer can indicate the successful completion of LTM cell switch to the RRC layer. The RRC layer can indicate SDU discard to PDCP layer, if configured. For SRBs, when upper layers (e.g. RRC layer) request a PDCP SDU discard, the PDCP entity shall discard all stored PDCP SDUs and PDCP PDUs. It is beneficial to discard old RRC messages of SRBs to prevent unnecessary (re-)transmission to the target cell. The PDCP SDU discard for SRBs (e.g. SRB1 or SRB3) can be triggered and performed when the LTM cell switch procedure fails (e.g. the supervisor timer for LTM cell switch is expired), in order to avoid unnecessary (re-)transmission of RRC message (e.g. RRC Reconfiguration Complete message for the target cell UE failed to LTM cell switch to). The RLC re-establishment for SRBs (e.g. SRB1 or SRB3) can be triggered and performed when the LTM cell switch procedure fails (e.g. the supervisor timer for LTM cell switch is expired), in order to avoid unnecessary (re-)transmission of RRC message (e.g. RRC Reconfiguration Complete message for the target cell UE failed to LTM cell switch to).

In another embodiment, upon the reception of MAC CE indicating LTM cell switch (or LTM cell switch execution), UE can apply the LTM candidate cell configuration and the indicators corresponding to the target cell (or indicated cell in MAC CE) to UE configuration. This approach can avoid UE's early application and revert it back when it fails, which eases UE implementation. This approach can avoid UE's early application. As the UE cannot know the time when the network sends MAC CE indicating LTM cell switch, UE can follow this approach to apply the configuration timely. The reception of MAC CE indicating LTM cell switch can implies LTM cell switch execution.
For example, upon the reception of MAC CE indicating LTM cell switch (or LTM cell switch execution), UE performs MAC reset (or partial MAC reset) if the indicator is configured in the stored configuration (e.g. LTM candidate cell configuration for LTM) corresponding to the target cell (or indicated cell in MAC CE or successfully switched cell), which can be done by applying the complete LTM cell configuration. Upon the reception of MAC CE indicating LTM cell switch (or LTM cell switch execution), the MAC layer can indicate the successful completion of LTM cell switch to the RRC layer. The RRC layer can indicate MAC reset (or partial MAC reset) to MAC layer, if configured.
For example, upon the reception of MAC CE indicating LTM cell switch (or LTM cell switch execution), UE performs RLC re-establishment if the indicator is configured in the stored configuration (e.g. LTM candidate cell configuration for LTM) corresponding to the target cell (or indicated cell in MAC CE or successfully switched cell), which can be done by applying the complete LTM cell configuration. Upon the reception of MAC CE indicating LTM cell switch (or LTM cell switch execution), the MAC layer can indicate the successful completion of LTM cell switch to the RRC layer. The RRC layer can indicate RLC re-establishment to RLC layer, if configured.
For example, upon the reception of MAC CE indicating LTM cell switch (or LTM cell switch execution), UE performs PDCP re-establishment if the indicator is configured in the stored configuration (e.g. LTM candidate cell configuration for LTM) corresponding to the target cell (or indicated cell in MAC CE or successfully switched cell), which can be done by applying the complete LTM cell configuration. Upon the reception of MAC CE indicating LTM cell switch (or LTM cell switch execution), the MAC layer can indicate the successful completion of LTM cell switch to the RRC layer. The RRC layer can indicate PDCP re-establishment to PDCP layer, if configured.
For example, upon the reception of MAC CE indicating LTM cell switch (or LTM cell switch execution), UE performs PDCP data recovery if the indicator is configured in the stored configuration (e.g. LTM candidate cell configuration for LTM) corresponding to the target cell (or indicated cell in MAC CE or successfully switched cell), which can be done by applying the complete LTM cell configuration. PDCP data recovery can be configured only for a PDCP entity associated with AM RLC entities (RLC entity with Acknowledged Mode (AM) mode). Upon the reception of MAC CE indicating LTM cell switch (or LTM cell switch execution), the MAC layer can indicate the successful completion of LTM cell switch to the RRC layer. The RRC layer can indicate PDCP data recovery to PDCP layer, if configured.
For example, upon the reception of MAC CE indicating LTM cell switch (or LTM cell switch execution), UE performs SDU discard in PDCP entity (i.e. PDCP SDU discard) if the indicator is configured in the stored configuration (e.g. LTM candidate cell configuration for LTM) corresponding to the target cell (or indicated cell in MAC CE or successfully switched cell), which can be done by applying the complete LTM cell configuration. SDU discard can be configured only for a PDCP entity of SRBs associated with AM RLC entities (RLC entity with Acknowledged Mode (AM) mode). Upon the reception of MAC CE indicating LTM cell switch (or LTM cell switch execution), the MAC layer can indicate the successful completion of LTM cell switch to the RRC layer. The RRC layer can indicate SDU discard to PDCP layer, if configured. For SRBs, when upper layers (e.g. RRC layer) request a PDCP SDU discard, the PDCP entity shall discard all stored PDCP SDUs and PDCP PDUs. It is beneficial to discard old RRC messages of SRBs to prevent unnecessary (re-) transmission to the target cell. The PDCP SDU discard for SRBs (e.g. SRB1 or SRB3) can be triggered and performed when the LTM cell switch procedure fails (e.g. the supervisor timer for LTM cell switch is expired), in order to avoid unnecessary (re-) transmission of RRC message (e.g. RRC Reconfiguration Complete message for the target cell UE failed to LTM cell switch to). The RLC re-establishment for SRBs (e.g. SRB1 or SRB3) can be triggered and performed when the LTM cell switch procedure fails (e.g. the supervisor timer for LTM cell switch is expired), in order to avoid unnecessary (re-)transmission of RRC message (e.g. RRC Reconfiguration Complete message for the target cell UE failed to LTM cell switch to).

In another embodiment, upon the reception of MAC CE indicating LTM cell switch (or LTM cell switch execution) or upon the reception of RRCReconfiguration message including the indicators (or the LTM cell candidate configuration is complete, i.e. if the LTM cell candidate configuration is indicated to be applied by an indicator), UE can apply the LTM candidate cell configuration (e.g. complete LTM cell configuration) and the indicators corresponding to the target cell (or indicated cell in MAC CE) to UE configuration. This approach can be efficiently performed by the network. For example, the network sends MAC CE indicating LTM cell switch and RRCReconfiguration message including indicators together (e.g. at a time or in the same MAC PDU) to make UE perform the following actions.
For example, upon the reception of MAC CE indicating LTM cell switch (or LTM cell switch execution) or upon the reception of RRCReconfiguration message including the indicators, UE performs MAC reset (or partial MAC reset) if the indicator is configured in the stored configuration (e.g. LTM candidate cell configuration for LTM) corresponding to the target cell (or indicated cell in MAC CE or successfully switched cell), which can be done by applying the complete LTM cell configuration. Upon the reception of MAC CE indicating LTM cell switch (or LTM cell switch execution), the MAC layer can indicate the successful completion of LTM cell switch to the RRC layer. The RRC layer can indicate MAC reset (or partial MAC reset) to MAC layer, if configured.
For example, upon the reception of RRCReconfiguration message including the indicators, UE performs RLC re-establishment if the indicator is configured in the stored configuration (e.g. LTM candidate cell configuration for LTM) corresponding to the target cell (or indicated cell in MAC CE or successfully switched cell), which can be done by applying the complete LTM cell configuration. Upon the reception of RRCReconfiguration message including the indicators, the MAC layer can indicate the successful completion of LTM cell switch to the RRC layer. The RRC layer can indicate RLC re-establishment to RLC layer, if configured.
For example, upon the reception of RRCReconfiguration message including the indicators, UE performs PDCP re-establishment if the indicator is configured in the stored configuration (e.g. LTM candidate cell configuration for LTM) corresponding to the target cell (or indicated cell in MAC CE or successfully switched cell), which can be done by applying the complete LTM cell configuration. Upon the reception of RRCReconfiguration message including the indicators, the MAC layer can indicate the successful completion of LTM cell switch to the RRC layer. The RRC layer can indicate PDCP re-establishment to PDCP layer, if configured.
For example, upon the reception of RRCReconfiguration message including the indicators, UE performs PDCP data recovery if the indicator is configured in the stored configuration (e.g. LTM candidate cell configuration for LTM) corresponding to the target cell (or indicated cell in MAC CE or successfully switched cell), which can be done by applying the complete LTM cell configuration. PDCP data recovery can be configured only for a PDCP entity associated with AM RLC entities (RLC entity with Acknowledged Mode (AM) mode). Upon the reception of RRCReconfiguration message including the indicators, the MAC layer can indicate the successful completion of LTM cell switch to the RRC layer. The RRC layer can indicate PDCP data recovery to PDCP layer, if configured.
For example, upon the reception of RRCReconfiguration message including the indicators UE performs SDU discard in PDCP entity (i.e. PDCP SDU discard) if the indicator is configured in the stored configuration (e.g. LTM candidate cell configuration for LTM) corresponding to the target cell (or indicated cell in MAC CE or successfully switched cell), which can be done by applying the complete LTM cell configuration. SDU discard can be configured only for a PDCP entity of SRBs associated with AM RLC entities (RLC entity with Acknowledged Mode (AM) mode). Upon the reception of RRCReconfiguration message including the indicators, the MAC layer can indicate the successful completion of LTM cell switch to the RRC layer. The RRC layer can indicate SDU discard to PDCP layer, if configured. For SRBs, when upper layers (e.g. RRC layer) request a PDCP SDU discard, the PDCP entity shall discard all stored PDCP SDUs and PDCP PDUs. It is beneficial to discard old RRC messages of SRBs to prevent unnecessary (re-)transmission to the target cell. The PDCP SDU discard for SRBs (e.g. SRB1 or SRB3) can be triggered and performed when the LTM cell switch procedure fails (e.g. the supervisor timer for LTM cell switch is expired), in order to avoid unnecessary (re-)transmission of RRC message (e.g. RRC Reconfiguration Complete message for the target cell UE failed to LTM cell switch to). The RLC re-establishment for SRBs (e.g. SRB1 or SRB3) can be triggered and performed when the LTM cell switch procedure fails (e.g. the supervisor timer for LTM cell switch is expired), in order to avoid unnecessary (re-)transmission of RRC message (e.g. RRC Reconfiguration Complete message for the target cell UE failed to LTM cell switch to)

NOTE: This delayed application of configuration is totally different from the legacy behavior because UE performs MAC reset/RLC/PDCP re-establishment, if configured, upon the reception of RRCReconfiguration in legacy procedure. In the above, the stored LTM candidate cell configuration can be regarded as reference configuration, which can be applied at a specific time as set out.
Security is not updated in LTM. In another embodiment, the network decides whether to update the security based on the type of mobility (e.g. to which cell UE is indicated to perform cell switch). For example, the security configuration for security update is not included in the LTM candidate cell configuration (RRCReconfiguration) for the case that this candidate cell belongs to intra-gNB-DU or intra-gNB-CU. However, the security configuration for security update is included in the LTM candidate cell configuration (RRCReconfiguration) for the case that this candidate cell belongs to inter-gNB-DU (i.e. inter-gNB-DU mobility case) When the condition for successful completion of LTM cell switch is met after triggering the LTM procedure (or cell switch) by a cell switch command through a MAC CE, UE applies and updates the security configuration to the current configuration, if configured.
Subsequent LTM between LTM candidate cell configurations (i.e., UE does not release other LTM candidate cell configurations after LTM is triggered) can be performed without RRC reconfiguration.

LTM supports both intra-gNB-DU and intra-gNB-CU inter-gNB-DU mobility. LTM also supports inter-frequency mobility, including mobility to inter-frequency cell that is not a current serving cell. The following scenarios are supported:
Primary cell (PCell) change in non-CA scenario,
PCell change without secondary cell (SCell) change in CA scenario,
PCell change with SCell change(s) in CA scenario, including the following cases:
a) The target PCell/target SCell(s) is not a current serving cell (CA-to-CA scenario with PCell change)
b) The target PCell is a current SCell
c) The target SCell is the current PCell.
   Dual connectivity scenario, at least for the primary secondary cell (PSCell) change without master node (MN) involvement case, i.e. intra-SN. When UE is configured with dual connectivity (i.e. Secondary Cell Group (SCG) and Master Cell Group (MCG)), For SCG (or LTM procedure for SCG), the LTM candidate cell configuration of SCG can be configured in RRCReconfiguration message via SRB3, i.e. it can be configured after SRB3 establishment. For SCG (or LTM procedure for SCG), the LTM candidate cell configuration of SCG cannot be configured via SRB1. For MCG (or LTM procedure for MCG), the LTM candidate cell configuration of MCG can be configured in RRCReconfiguration message via SRB1, i.e. it can be configured after SRB1 establishment.

To support the above scenarios, additional procedures may be needed. For example, when the scenario, b) The target PCell is a current SCell, is considered in LTM configuration and LTM procedure (or execution or cell switch), the Random Access procedure for TA acquisition of LTM candidate cell can be performed on the SCell if the SCell is activated (or in activated state). However, if the SCell is deactivated (in deactivated state), the Random Access procedure for TA acquisition of LTM candidate cell cannot be performed on the SCell as the SCell is off. To support this scenario, we can go for one of the following options to easy UE and network implementation.
Option 1: As UE cannot perform the Random Access procedure (i.e. transmit on RACH or perform RACH) on the deactivated SCell, the network does not indicate LTM cell switch (or Random access procedure for TA acquisition) to the deactivated SCell as the target LTM candidate cell. The network does not send the first MAC CE (LTM Command MAC CE) including the indicator (or identity) for LTM candidate configuration to a UE if the configuration corresponds to the deactivated SCell of UE. In other words, UE does not expect the reception of the first MAC CE indicating LTM execution to the deactivated SCell of UE. In this option, “b) The target PCell is a current SCell” can be restricted to the case that the target PCell is a current activated SCell, i.e. the network can indicate LTM cell switch to the activated SCell as the target LTM candidate cell. The network can send the first MAC CE (LTM Command MAC CE) including the indicator (or identity) for LTM candidate configuration to a UE if the configuration corresponds to the activated SCell of UE.
Option 2: In this option, we can allow UE to perform the Random Access procedure on a deactivated (or an activated) SCell when the Random Access procedure (i.e. transmit on RACH or perform RACH) is triggered by PDCCH order to acquire TA of the SCell and the SCell is one of LTM candidate cells configured to UE. Except for this case, we do not allow UE to perform RACH on the deactivated SCell. Therefore, the network can indicate LTM cell switch to the deactivated SCell (or activated SCell) as the target LTM candidate cell. The network can send the first MAC CE (LTM Command MAC CE) including the indicator (or identity) for LTM candidate configuration to a UE regardless of SCell state. To enable this option (i.e. to support the scenario b)), the following procedure is provided:
1> if the SCell is deactivated;
2> not transmit SRS on the SCell;
2> not report CSI for the SCell;
2> not transmit on UL-SCH on the SCell;
2> not transmit on RACH on the SCell, except when the Random Access procedure (i.e. RACH) is initiated by the PDCCH order for the LTM candidate cell (i.e. the SCell) for TA acquisition of the SCell or when the SCell is configured as one of LTM candidate cell or when the SCell is the LTM candidate cell;
2> not monitor the PDCCH on the SCell;
2> not monitor the PDCCH for the SCell;
2> not transmit PUCCH on the SCell.
Option 3: In this option, LTM supports both intra-gNB-DU and intra-gNB-CU inter-gNB-DU mobility. LTM also supports inter-frequency mobility, including mobility to inter-frequency cell that is not a current serving cell (i.e. PCell, PSCell or SCell). In other words, the network does not indicate LTM cell switch (or Random access procedure for TA acquisition) to the current serving cell (i.e. PCell, PSCell or SCell) of the UE as the target LTM candidate cell. The network does not send the first MAC CE (LTM Command MAC CE) including the indicator (or identity) for LTM candidate configuration to a UE if the configuration corresponds to the current serving cell of UE. In other words, UE does not expect the reception of the first MAC CE indicating LTM execution to the current serving cell of UE. In another embodiment, the network does not configure LTM candidate configuration corresponding the current serving cell of a UE to the UE. This configuration restriction can work the same as the intention of this option, i.e. the network cannot indicate LTM cell switch (or Random access procedure for TA acquisition) to the current serving cell (i.e. PCell, PSCell or SCell) of the UE as the target LTM candidate cell. The network can indicate LTM cell switch (or Random access procedure for TA acquisition) to a candidate cell except the current serving cell (i.e. PCell, PSCell or SCell) of the UE as the target LTM candidate cell. The network can send the first MAC CE (LTM Command MAC CE) including the indicator (or identity) for LTM candidate configuration to a UE if the configuration does not correspond to the current serving cell of UE.

A supervision timer can be used to detect failure of LTM cell switch procedure, wherein LTM procedure fails if the LTM supervision timer expires, upon which the UE initiates RRC connection re-establishment procedure. The behavior for the supervision timer is as follows:

The LTM supervisor timer (ex. Txx timer) can be managed for each cell group (e.g. MCG or SCG) in RRC layer.

The UE starts the LTM supervisor timer, upon reception of the LTM cell switch MAC CE. The UE can restart the LTM supervisor timer upon reception of the LTM cell switch MAC CE indicating subsequent LTM. For example, the UE can start or restart the LTM supervisor timer, upon reception of the LTM cell switch MAC CE.

The UE stops the LTM supervisor timer, upon successful completion of LTM cell switch or upon the detection of beam failure (i.e. if BFI_COUNTER>=beamFailureInstanceMaxCount for the target/indicated LTM candidate cell (or PTAG or the serving cell or the target cell)) or upon the reception of RRCReconfiguration including reconfigurationWithSync.

For MCG, a supervision timer can be used to detect failure of LTM cell switch procedure, wherein LTM procedure fails if the LTM supervision timer expires, upon which the UE initiates RRC connection re-establishment procedure to recover RRC connection (i.e. MCG connection or link).

For SCG, a supervision timer can be used to detect failure of LTM cell switch procedure, wherein LTM procedure fails if the LTM supervision timer expires, upon which the UE initiates SCG failure information procedure to report SCG failure to the network.

While the UE has stored LTM candidate cell configurations the UE can also execute any L3 handover command sent by the network. It is up to the network to avoid any issue due to a collision between LTM execution and L3 handover execution, e.g. avoiding sending LTM cell switch command and L3 handover command simultaneously.

The following relates to Control Plane (CP) handling.

Cell switch trigger is conveyed in a MAC CE (i.e. the first MAC CE described in Section 4.1), which contains at least a candidate configuration index together with beam indication.

UE may perform contention-based random access (CBRA) or contention-free random access procedure (CFRA) at cell switch. UE may also skip random access procedure (i.e. RACH-less solution) if UE doesn't need to acquire TA for the target cell during cell switch.

FIG. 1 illustrates a signalling procedure for LTM according to an embodiment of the disclosure.

The overall procedure for LTM is shown in FIG. 1. Subsequent LTM is done by repeating the early synchronization, LTM execution, and LTM completion steps without releasing other LTM candidate cell configurations after each LTM completion.

The procedure for LTM is as follows.
1. The UE sends a MeasurementReport message to the gNB. The gNB decides to use LTM and initiates candidate cell(s) preparation.
2. The gNB transmits an RRCReconfiguration message to the UE including the LTM candidate cell configurations of one or multiple candidate cells.
3. The UE stores the LTM candidate cell configurations and transmits a RRCReconfigurationComplete message to the gNB.
4a. The UE may perform DL synchronization with candidate cell(s) before receiving the cell switch command. DL synchronization for candidate cell(s) before cell switch command can be supported, at least based on synchronization signal block (SSB).
4b. The UE may perform early TA acquisition with candidate cell(s) requested by the network before receiving the cell switch command. This is done via Random access procedure (i.e. Contention-Free Random Access procedure (CFRA)) triggered by a PDCCH order from the source cell, following which the UE sends preamble towards the indicated candidate cell. In order to minimize the data interruption of the source cell due to CFRA towards the candidate cell(s), the UE doesn't receive Random Access Response (RAR) for the purpose of TA value acquisition and the TA value of the candidate cell is indicated in the cell switch command (i.e. the first MAC CE described in Section 4.1). The UE doesn't maintain the TA timer for the candidate cell and relies on network implementation to guarantee the TA validity.
synchronization for candidate cell(s) before cell switch command is supported, at least based on SSB. FFS necessary mechanism.

In this disclosure, TA acquisition of candidate cell(s) before LTM cell switch command is supported, at least based on PDCCH ordered RACH, where the PDCCH order is only triggered by source cell. The source cell can trigger UE's Random Access Procedure (RACH) toward a candidate cell by PDCCH order to acquire Timing Advance or Timing Advance value (TA) for the candidate cell, which only performs preamble transmission and does not expect the reception of Random Access Response (RAR) to ease network implementation and UE implementation. Specifically, the preamble transmission during this Random Access procedure (RACH) for TA acquisition (i.e. early RACH) can be considered as this Random Access procedure is successfully completed. To reduce the processing complexity, UE does not have to calculate Radio Network Temporary Identifier (RNTI) for Random Access Response (RA-RNTI) before/when the preamble is transmitted, unlike normal Random Access procedure (RACH). To be more specific, UE transmits preamble to a candidate cell as indicated by PDCCH order. The network (or Distributed Unit (DU) or the candidate cell) calculates the Timing Advance (TA). The source cell/DU can get the calculated TA from the candidate cell/DU. By doing this Random Access procedure (RACH) for TA acquisition (i.e. early RACH), the network can have the TA values for the candidate cells and knows whether these TAs are still valid or not, e.g., by maintaining a network side timer (i.e. timeAlignmentTimer (TAT) for each TA value or each candidate cell). In this way, the source cell/DU gets to know the value and the validity of candidate cell TA. The source cell/DU needs to know whether a candidate cell TA is still valid because the source cell/DU needs to determine whether it can initiate a RACH-less solution for LTM cell switch and then determine whether it needs to include a beam indication (e.g. transmission configuration indicator (TCI) state) and TA information in the LTM MAC CE. Therefore, the network can indicate a valid TA to the UE or indicate whether a TA is still valid in LTM MAC CE. The UE may not need to maintain a TA timer for candidate cells, which simplifies UE implementation. Upon the reception of the TA information indicated in LTM MAC CE, the UE can apply the TA value and start the TA timer for the target LTM candidate cell upon LTM execution (i.e. LTM cell switch) and UE can perform LTM cell switch without Random access procedure (i.e. with RACH-less solution) if TAT for the target LTM candidate cell is running (i.e. TA value is valid) or if Beam failure is not detected for the target LTM candidate cell, which means that UE can monitor PDCCH from the target LTM candidate cell or UE can use configured grants the first UL data transmission to the target cell for RACH-less LTM execution (LTM cell switch).
5. The UE performs L1 measurements on the configured candidate cell(s), and transmits lower-layer measurement reports to the gNB.
6. The gNB decides to execute cell switch to a target cell, and transmits a MAC CE triggering cell switch by including the candidate configuration index of the target cell. The UE switches to the configuration of the target cell.
7. The UE performs random access procedure towards the target cell, if cell switch needs to include performing random access procedure.
8. The UE completes the LTM cell switch procedure by sending RRCReconfigurationComplete message to target cell. If the UE has performed a RA procedure in step 7, the UE considers that LTM execution is successfully completed when the random access procedure is successfully completed. For RACH-less LTM, the UE considers that LTM execution is successfully completed when the UE determines that the network has successfully received its first UL data.

The UE can perform the steps 4-8 multiple times for subsequent LTM cell switch based on the configuration provided in step 2.

### 2.1.2 User Plane (U-Plane) Handling

In LTM, whether the UE performs partial or full MAC reset, re-establishes RLC, performs data recovery with PDCP during cell switch is explicitly controlled by the network through RRC signalling.
MAC/RLC re-establishment/PDCP data recovery/PDCP re-establishment (when configured)
RF retuning (e.g. needed for inter-frequency), baseband retuning

The PDCP data recovery procedure can be applied to the RLC AM bearers for inter-DU LTM cell switch.

### 2.3 Principles for Security Protection

The following high-level principles should be applied. In this disclosure, the security protection implies ciphering or integrity protection. The ciphering means not only the ciphering operation but also the deciphering operation because the deciphering should be applied to the data at the receiver if a data is ciphered at the transmitter. Likewise, the integrity protection means the integrity verification operation as well as the integrity protection operation because the integrity verification should be applied to the data at the receiver if a data is integrity protected at the transmitter.

AS security comprises of the integrity protection and ciphering of RRC signalling (SRBs) and user data (data radio bearers (DRBs)).

RRC handles the configuration of the AS security parameters which are part of the AS configuration: the integrity protection algorithm, the ciphering algorithm, if integrity protection and/or ciphering is enabled for a DRB and two parameters, namely the keySetChangeIndicator and the nextHopChainingCount, which are used by the UE to determine the AS security keys upon reconfiguration with sync (with key change), connection re-establishment and/or connection resume.

The integrity protection algorithm is common for SRB1, SRB2, SRB3 (if configured), SRB4 (if configured), SRBx (if configured) and DRBs configured with integrity protection, with the same keyToUse value. The ciphering algorithm is common for SRB1, SRB2, SRB3 (if configured), SRB4 (if configured), SRBx (if configured) and DRBs configured with the same keyToUse value. Neither integrity protection nor ciphering applies for SRB0.

NOTE 0: All DRBs related to the same PDU session have the same enable/disable setting for ciphering and the same enable/disable setting for integrity protection.

RRC integrity protection and ciphering are always activated together, i.e. in one message/procedure. RRC integrity protection and ciphering for SRBs are never de-activated. However, it is possible to switch to a ‘NULL’ ciphering algorithm (nea0).

For SRBx (if configured), RRC integrity protection and ciphering can be activated and deactivated based on configuration or indication by RRC messages (or MAC Control Element (CE) or PDCP control Protocol Data Unit (PDU)), in order to reduce the UE processing burden. For SRBx (if configured), it is also possible to switch to a ‘NULL’ ciphering algorithm (nea0) and the ‘NULL’ integrity protection algorithm (nia0) can be used.

The ‘NULL’ integrity protection algorithm (nia0) is used only for SRBs and for the UE in limited service mode and when used for SRBs, integrity protection is disabled for DRBs. In case the ‘NULL’ integrity protection algorithm is used, ‘NULL’ ciphering algorithm is also used.

NOTE 1: Lower layers discard RRC messages for which the integrity protection check has failed and indicate the integrity protection verification check failure to RRC.

The AS applies four different security keys: one for the integrity protection of RRC signalling (K_{RRCint}), one for the ciphering of RRC signalling (K_{RRCenc}), one for integrity protection of user data (K_{UPint}) and one for the ciphering of user data (K_{UPenc}). All four AS keys are derived from the K_{gNB} key. The K_{gNB} key is based on the KAME key, which is handled by upper layers.

The integrity protection and ciphering algorithms can only be changed with reconfiguration with sync. The AS keys (K_{gNB}, K_{RRCint}, K_{RRCenc}, K_{UPint} and K_{UPenc}) change upon reconfiguration with sync (if masterKeyUpdate is included), and upon connection re-establishment and connection resume.

For each radio bearer an independent counter (COUNT used in PDCP layer) is maintained for each direction. For each radio bearer, the COUNT is used as input for ciphering and integrity protection.

It is not allowed to use the same COUNT value more than once for a given security key. The network is responsible for avoiding reuse of the COUNT with the same RB identity and with the same key, e.g. due to the transfer of large volumes of data, release and establishment of new RBs, and multiple termination point changes for RLC-UM bearers and multiple termination point changes for RLC-AM bearer with SN terminated PDCP re-establishment (COUNT reset) due to SN only full configuration whilst the key stream inputs (i.e. bearer ID, security key) at MN have not been updated. In order to avoid such re-use, the network may e.g. use different RB identities for RB establishments, change the AS security key, or an RRC_CONNECTED to RRC_IDLE/RRC_INACTIVE and then to RRC_CONNECTED transition.

In order to limit the signalling overhead, individual messages/packets include a short sequence number (PDCP Sequence Number (SN)). In addition, an overflow counter mechanism is used: the hyper frame number (HFN used in PDCP layer). The HFN needs to be synchronized between the UE and the network.

For each SRB, the value provided by RRC to lower layers to derive the 5-bit BEARER parameter used as input for ciphering and for integrity protection is the value of the corresponding srb-Identity with the MSBs padded with zeroes.

For a UE provided with an sk-counter, keyToUse indicates whether the UE uses the master key (K_{gNB}) or the secondary key (S-K_{eNB} or S-K_{gNB}) for a particular DRB. The secondary key is derived from the master key and sk-Counter. Whenever there is a need to refresh the secondary key, e.g. upon change of MN with K_{gNB} change or to avoid COUNT reuse, the security key update is used. When the UE is in NR-DC, the network may provide a UE configured with an SCG with an sk-Counter even when no DRB is setup using the secondary key (S-K_{gNB}) in order to allow the configuration of SRB3. The network can also provide the UE with an sk-Counter, even if no SCG is configured, when using SN terminated MCG bearers.

The following relates to RRC Protocol.

A UE is either in RRC_CONNECTED state or in RRC_INACTIVE state when an RRC connection has been established. If this is not the case, i.e. no RRC connection is established, the UE is in RRC_IDLE state. The RRC states can further be characterized as follows:

### RRC_IDLE:

A UE specific discontinuous reception (DRX) may be configured by upper layers;
At lower layers, the UE may be configured with a DRX for point to multipoint (PTM) transmission of multicast and broadcast service (MBS) broadcast; UE controlled mobility based on network configuration;

The UE:
Monitors Short Messages transmitted with paging-RNTI (P-RNTI) over downlink control information (DCI) (downlink control information) (see clause 6.5);
Monitors a Paging channel for core network (CN) paging using 5G-S-TMSI, except if the UE is acting as a L2 U2N Remote UE;
If configured by upper layers for MBS multicast reception, monitors a Paging channel for CN paging using temporary mobile group identity (TMGI);
Performs neighbouring cell measurements and cell (re-) selection;
Acquires system information and can send SI request (if configured);
Performs logging of available measurements together with location and time for logged measurement configured UEs;
Performs idle/inactive measurements for idle/inactive measurement configured UEs;
Performs AI/ML functionality (e.g. collection of AI/ML data or measurements for AI/ML data or reporting AI/ML data) configured UEs;
If configured by upper layers for MBS broadcast reception, acquires multicast control channel (MCCH) change notification and MBS broadcast control information and data.

### RRC_INACTIVE:

A UE specific DRX may be configured by upper layers or by RRC layer;
At lower layers, the UE may be configured with a DRX for PTM transmission of MBS broadcast;
UE controlled mobility based on network configuration;
The UE stores the UE Inactive access stratum (AS) context;
A RAN-based notification area is configured by RRC layer;
Transfer of unicast data and/or signalling to/from UE over radio bearers configured for small data transmission (SDT).

The UE:
Monitors Short Messages transmitted with P-RNTI over DCI (see clause 6.5);
During small data transmission (SDT) procedure, monitors control channels associated with the shared data channel to determine if data is scheduled for it;
While SDT procedure is not ongoing, monitors a Paging channel for CN paging using 5G-S-TMSI and RAN paging using full I-RNTI, except if the UE is acting as a L2 U2N Remote UE;
If configured by upper layers for MBS multicast reception, while SDT procedure is not ongoing, monitors a Paging channel for paging using TMGI;
Performs neighbouring cell measurements and cell (re-) selection;
Performs RAN-based notification area updates periodically and when moving outside the configured RAN-based notification area;
Acquires system information, while SDT procedure is not ongoing, and can send SI request (if configured);
While SDT procedure is not ongoing, performs logging of available measurements together with location and time for logged measurement configured UEs;
While SDT procedure is not ongoing, performs idle/inactive measurements for idle/inactive measurement configured UEs;
While SDT procedure is not ongoing, performs AI/ML functionality (e.g. collection of AI/ML data or measurements for AI/ML data or reporting AI/ML data) configured UEs;
If configured by upper layers for MBS broadcast reception, acquires MCCH change notification and MBS broadcast control information and data;
Transmits SRS (sounding reference signal) for Positioning.

### RRC_CONNECTED:

The UE stores the AS context;
Transfer of unicast data to/from UE;
Transfer of MBS multicast data to UE;
At lower layers, the UE may be configured with a UE specific DRX;
At lower layers, the UE may be configured with a DRX for PTM transmission of MBS broadcast and/or a DRX for MBS multicast;
For UEs supporting CA (carrier aggregation), use of one or more SCells, aggregated with the SpCell, for increased bandwidth;
For UEs supporting dual connectivity (DC), use of one secondary cell group (SCG), aggregated with the master cell group (MCG), for increased bandwidth;
Network controlled mobility within NR, to/from E-UTRA, and to UTRA-frequency division duplex (FDD);
Network controlled mobility (path switch) between a serving cell and a L2 U2N Relay UE, or vice versa.

The UE:
Monitors Short Messages transmitted with P-RNTI over DCI (see clause 6.5), if configured;
Monitors control channels associated with the shared data channel to determine if data is scheduled for it;
Provides channel quality and feedback information;
Performs neighbouring cell measurements and measurement reporting;
Performs AI/ML functionality (e.g. collection of AI/ML data or measurements for AI/ML data or reporting AI/ML data) configured UEs;
Acquires system information;
Performs immediate minimization of drive test (MDT) measurement together with available location reporting;
If configured by upper layers for MBS broadcast reception, acquires MCCH change notification and MBS broadcast control information and data.

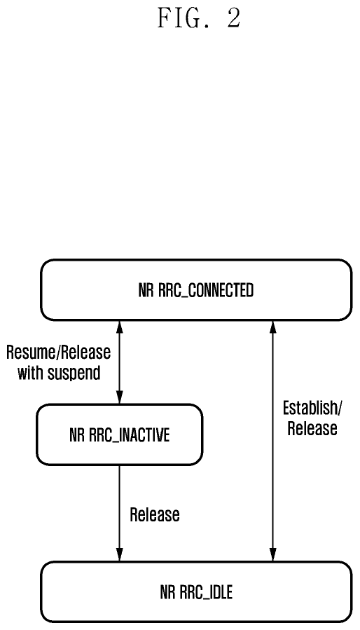

FIG. 2 illustrates an overview of UE RRC state machine and state transitions in NR. A UE has only one RRC state in NR at one time according to an embodiment of the disclosure.

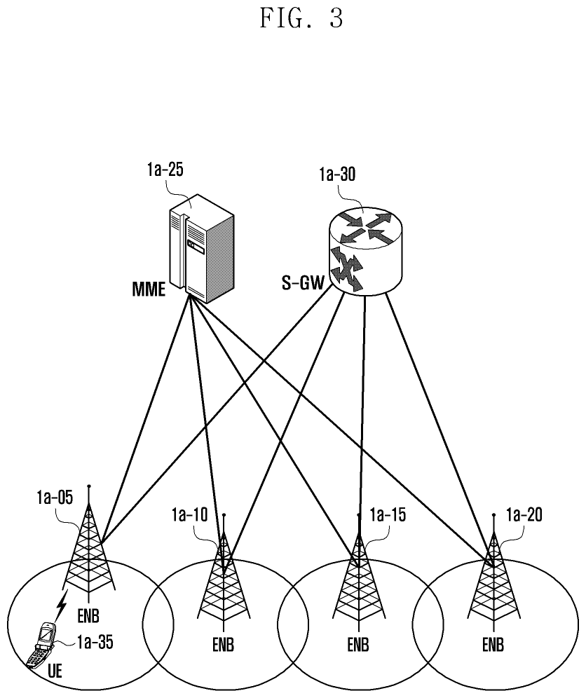

FIG. 3 illustrates the structure of a long term evolution (LTE) system according to an embodiment of the disclosure.

Referring to FIG. 3, a radio access network of an LTE system includes next-generation base stations (also referred to as evolved node Bs, hereinafter eNBs, node Bs, or base stations) 1a-05, 1a-10, 1a-15, and 1a-20, a mobility management entity (MME) 1a-25, and a serving gateway (S-GW) 1a-30. A user equipment (hereinafter UE or terminal) 1a-35 accesses an external network through the eNBs 1a-05 to 1a-20 and S-GW 1a-30.

In FIG. 3, the eNBs 1a-05 to 1a-20 correspond to an existing node B of an UMTS system. The eNBs are connected to the UE 1a-35 through a radio channel, and perform a more complicated role than the existing node B. In the LTE system, since all user traffic pertaining to real-time service, such as voice over internet protocol (VOIP), via the Internet protocol, is serviced through a shared channel, a device that performs scheduling by collecting state information, such as buffer states, available transmit power states, and channel states of UEs, is required, and eNBs 1a-05 to 1a-20 are in charge of this function of the device. In general, one eNB controls multiple cells. For example, in order to implement a transmission rate of 100 Mbps, the LTE system uses orthogonal frequency division multiplexing (OFDM) as a radio access technology in the bandwidth of 20 MHZ. In addition, the LTE system adopts an adaptive modulation & coding (hereinafter referred to as adaptive modulation & coding (AMC)) scheme for determining a modulation scheme and a channel coding rate based on the channel state of the UE. The S-GW 1a-30 is a device for providing a data bearer and generating or removing a data bearer under the control of the MME 1a-25. The MME is in charge of various control functions in addition to a mobility management function for the UE, and is connected to multiple base stations.

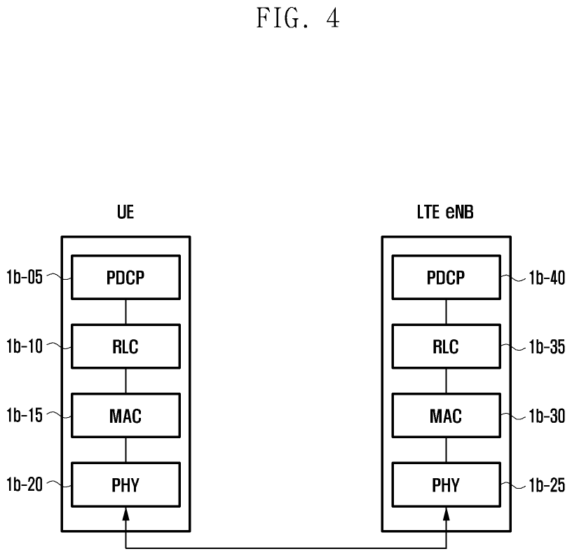

FIG. 4 illustrates a radio protocol structure in an LTE system according to an embodiment of the disclosure.

Referring to FIG. 4, the radio protocol of the LTE system includes packet data convergence protocols (PDCPs) 1b-05 and 1b-40, radio link controls (RLCs) 1b-10 and 1b-35, and medium access controls (MACs) 1b-15 and 1b-30, in a UE and an eNB, respectively. The packet data convergence protocols (PDCPs) 1b-05 and 1b-40 are used to perform operations, such as IP header compression/restoration. The main functions of PDCPs are summarized as follows.
Header compression and decompression: ROHC only
Transfer of user data
In-sequence delivery of upper layer PDUs at PDCP re-establishment procedure for RLC acknowledged mode (AM)
Sequence reordering (for split bearers in DC (only support for RLC AM): PDCP PDU routing for transmission and PDCP PDU reordering for reception)
Duplicate detection of lower layer service data units (SDUs) in a PDCP re-establishment procedure for RLC AM
Retransmission of PDCP SDUs at handover and, for split bearers in DC, of PDCP PDUs at PDCP data-recovery procedure, for RLC AM)
Ciphering and deciphering
Timer-based SDU discard in uplink

The radio link control (hereinafter referred to as RLC) 1b-10 and 1b-35 performs automatic repeat request (ARQ) operation by reconfiguring a PDCP protocol data unit (PDU) or RLC service data unit (SDU) to an appropriate size. The main functions of RLC are summarized below.
Transfer of upper layer PDUs
ARQ function (Error correction through ARQ (only for AM data transfer))
Concatenation, segmentation and reassembly of RLC SDUs (only for unacknowledged mode (UM) and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

The MACs 1b-15 and 1b-30 are connected to multiple RLC layer devices configured in one UE, and may perform an operation of multiplexing RLC PDUs to MAC PDUs and demultiplexing RLC PDUs from MAC PDUs. The main functions of MACs are summarized as follows.
Mapping between logical channels and transport channels
Multiplexing/de-multiplexing of MAC SDUs belonging to one or different logical channels into/from transport blocks (TB) transferred to/from the physical layer on transport channels
Scheduling information reporting
Error correction through hybrid automatic repeat request hybrid ARQ (HARQ)
Priority handling between logical channels of one UE
Priority handling between UEs by means of dynamic scheduling
Multimedia broadcast and multicast service (MBMS) service identification
Transport format selection
Padding

Physical layers 1b-20 and 1b-25 may perform operations of channel coding and modulating upper layer data, forming the upper layer data into an OFDM symbol, transmitting the OFDM symbol through a radio channel, or of demodulating an OFDM symbol received through a radio channel, channel-decoding the OFDM symbol, and transmitting the OFDM symbol to an upper layer.

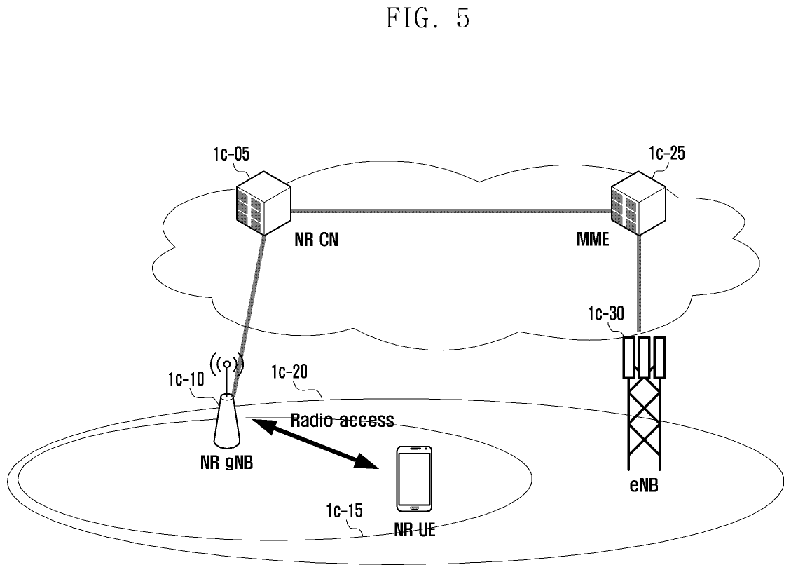

FIG. 5 illustrates the structure of a next-generation mobile communication system according to an embodiment of the disclosure.

Referring to FIG. 5, a radio access network of a next-generation mobile communication system (hereinafter referred to as NR (new radio) or 5G) includes a new radio node B (hereinafter referred to as an NR gNB, or NR base station) 1c-10 and a new radio core network (NR CN) 1c-05. A user terminal (a new radio user equipment, hereinafter referred to as NR UE or a UE) 1c-15 accesses an external network via an NR gNB 1c-10 and an NR CN 1c-05.

In FIG. 5, the NR gNB 1c-10 corresponds to an evolved node B (eNB) of the existing LTE system. The NR gNB is connected to the NR UE 1c-15 via a radio channel, and may provide an excellent service as compared to the existing node B. In the next-generation mobile communication system, since all types of user traffics are serviced through a shared channel, there is a need for a device for performing scheduling by collecting state information, such as buffer states, available transmission power states, and channel states of UEs. Further, the NR NB 1c-10 is in charge of this function of the device. In general, one NR gNB typically controls multiple cells. In order to implement ultra-high speed data transmission as compared to the existing LTE, the NR gNB may have the existing maximum bandwidth or more, and may additionally employ beamforming technology using orthogonal frequency division multiplexing (hereinafter referred to as OFDM) as a radio access technology. In addition, the NR gNB adopts an adaptive modulation & coding (AMC) scheme that determines a modulation scheme and a channel coding rate based on the channel state of a UE. The NR CN 1c-05 performs functions, such as mobility support, bearer configuration, quality of service (QOS) configuration, and the like. The NR CN is a device that is in charge of various control functions in addition to a mobility management function for a UE, and is connected to multiple base stations. In addition, the next-generation mobile communication system may also operate in conjunction with the existing LTE system, and the NR CN may be connected to an MME 1c-25 via a network interface. The MME is connected to an eNB 1c-30, that is, to the existing base station having a cell coverage 1c-20.

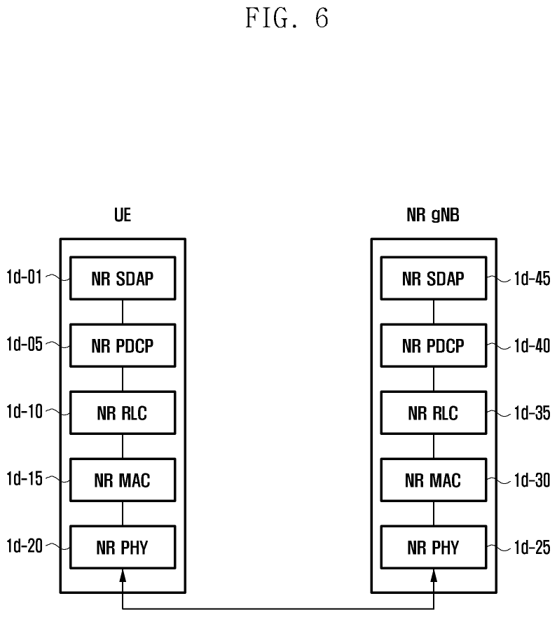

FIG. 6 illustrates a radio protocol structure of a next-generation mobile communication system according to an embodiment of the disclosure.

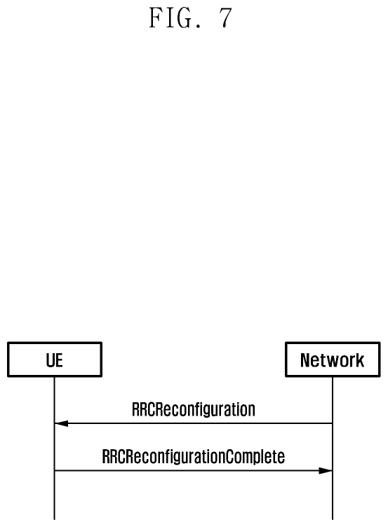

FIG. 7 illustrates RRC a successful reconfiguration according to an embodiment of the disclosure.

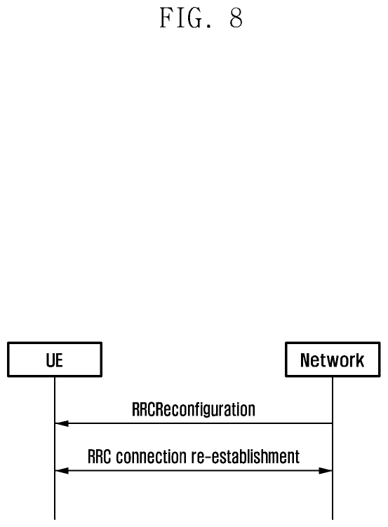

FIG. 8 illustrates an RRC reconfiguration failure according to an embodiment of the disclosure.

Referring to FIG. 6, the radio protocol of the next-generation mobile communication system includes NR service data adaptation protocols (SDAPs) 1d-01 and 1d-45, NR PDCPs 1d-05 and 1d-40, NR RLCs 1d-10 and 1d-35, and NR MACs 1d-15 and 1d-30, respectively, in a UE and an NR base station.

The main functions of the NR SDAPs 1d-01 and 1d-45 may include some of the following functions.
Transfer of user plane data
Mapping between a quality of service (QOS) flow and a data radio bearer (DRB) for both downlink (DL) and uplink (UL)
Marking QoS flow ID in both DL and UL packets
Mapping reflective QoS flow to DRB for the UL SDAP PDUs

For the SDAP layer device, the UE may be configured as to whether or not use the header of the SDAP layer device (or new layer device) or the function of the SDAP layer device (or new layer device) for each PDCP layer device, for each bearer, and for each logical channel through an RRC message. When the SDAP header is configured, an NAS reflective QoS reflective configuration 1-bit indicator (NAS reflective QoS) and an AS QoS reflective configuration 1-bit indicator (AS reflective QoS) of the SDAP header are used to instruct the UE to enable updating or reconfiguration of the mapping information relating to the QoS flow of uplink and downlink and data bearer. The SDAP header may include QoS flow ID information indicating QoS. The QoS information may be used as data processing priority, scheduling information, etc., in order to support a smooth service.

The main functions of the NR PDCPs 1d-05 and 1d-40 may include some of the following functions.
Header compression and decompression (ROHC only)
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The reordering function of the NR PDCP device refers to a function of sequentially reordering PDCP PDUs, received from a lower layer, based on a PDCP sequence number (SN), and may include a function of transmitting data to an upper layer in the reordered sequence, a function of directly transmitting data to an upper layer without taking the sequence into consideration, a function of reordering the sequence and recording missing PDCP PDUs, a function of providing a state report on the missing PDCP PDUs to a transmission side, and a function of requesting retransmission of the missing PDCP PDUS.

The main functions of the NR RLCs 1d-10 and 1d-35 may include some of the following functions.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The in-sequence delivery function of the NR RLC device refers to a function of transmitting RLC SDUs, received from a lower layer, to an upper layer in a sequence of reception, and may include, if one RLC SDU is originally segmented into multiple RLC SDUs and received, a function of reassembling and transmitting the multiple RLC SDUs. The in-sequence delivery function may include a function of reordering the received RLC PDUs based on an RLC SN or PDCP SN, reordering the sequence and recording missing RLC PDUs, providing a state report on the missing RLC PDUs to a transmission side, and requesting retransmission of the missing RLC PDUs. Alternatively, the in-sequence delivery function of the NR RLC device may include a function of sequentially transmitting only RLC SDUs prior to the missing RLC SDU to an upper layer if an RLC SDU is missing, or sequentially transmitting all the RLC SDUs received before a timer starts to an upper layer if the timer expires even if there is a missing RLC SDU, or sequentially transmitting all RLC SDUs received so far to an upper layer if a predetermined timer expires even if there is a missing RLC SDU. In addition, the RLC PDUs may be processed in the sequence in which the RLC PDUS are received (in a sequence of arrival regardless of the serial number or sequence number), and may be transmitted to a PDCP device in out-of-sequence delivery. The in-sequence delivery function may include a function of receiving segments stored in a buffer or segments to be received later, reconfiguring the segments in one complete RLC PDU, processing the RLC PDU, and transmitting the RLC PDU to the PDCP device. The NR RLC layer may not include a concatenation function, and the concatenation function may be performed by the NR MAC layer, or may be replaced by a multiplexing function of the NR MAC layer.

The out-of-sequence delivery function of the NR RLC device refers to a function of directly transmitting the RLC SDUs, received from the lower layer, to an upper layer regardless of the order thereof, and may include, if one RLC SDU has been originally segmented into multiple RLC SDUs and received, a function of reassembling the multiple RLC SDUs and transmitting the same, and a function of storing the RLC SNs or PDCP SNs of the received RLC PDUs, reordering the sequence, and recording the missing RLC PDUs.

The NR MACs 1d-15 and 1d-30 may be connected to multiple NR RLC layer devices configured in one UE, and the main function of the NR MAC may include some of the following functions.
Mapping between logical channels and transport channels
Multiplexing/de-multiplexing of MAC SDUs
Scheduling information reporting
Error correction through HARQ
Priority handling between logical channels of one UE
Priority handling between UEs by means of dynamic scheduling
MBMS service identification
Transport format selection
Padding

The NR PHY layers 1d-20 and 1d-25 may perform operations of channel-coding and modulating upper layer data, forming the upper layer data into an OFDM symbol, transmitting the OFDM symbols via a radio channel or demodulating and channel decoding of the OFDM symbols received via the radio channel, and transferring the OFDM symbol to an upper layer.

The following relates to RRC Procedures.

### RRC Reconfiguration.

The purpose of this procedure is to modify an RRC connection, e.g. to establish/modify/release RBs/BH RLC channels/Uu Relay RLC channels/PC5 Relay RLC channels, to perform reconfiguration with sync, to setup/modify/release measurements, to add/modify/release SCells and cell groups, to add/modify/release conditional handover configuration, to add/modify/release conditional PSCell change or conditional PSCell addition configuration, to add/modify/LTM candidate cells. As part of the procedure, NAS dedicated information may be transferred from the Network to the UE.

RRC reconfiguration to perform reconfiguration with sync includes, but is not limited to, the following cases:
reconfiguration with sync and security key refresh, involving RA to the PCell/PSCell, MAC reset, refresh of security and re-establishment of RLC and PDCP triggered by explicit L2 indicators;
reconfiguration with sync but without security key refresh, involving RA to the PCell/PSCell, MAC reset and RLC re-establishment and PDCP data recovery (for AM DRB or AM MRB) triggered by explicit L2 indicators.
reconfiguration with sync for DAPS and security key refresh, involving RA to the target PCell, establishment of target MAC, and
for non-dual active protocol stack (DAPS)) bearer: refresh of security and re-establishment of RLC and PDCP triggered by explicit L2 indicators;
for DAPS bearer: establishment of RLC for the target PCell, refresh of security and reconfiguration of PDCP to add the ciphering function, the integrity protection function and robust header compression (ROHC) function of the target PCell;
for signalling radio bearer (SRB): refresh of security and establishment of RLC and PDCP for the target PCell;
reconfiguration with sync for DAPS but without security key refresh, involving RA to the target PCell, establishment of target MAC, and
for non-DAPS bearer: RLC re-establishment and PDCP data recovery (for AM DRB or AM MRB) triggered by explicit L2 indicators.
for DAPS bearer: establishment of RLC for target PCell, reconfiguration of PDCP to add the ciphering function, the integrity protection function and ROHC function of the target PCell;
for SRB: establishment of RLC and PDCP for the target PCell.
reconfiguration with sync for direct-to-indirect path switch, not involving RA at target side, involving re-establishment of PDCP/PDCP data recovery (for AM DRB) triggered by explicit L2 indicators.

In (NG) EN-DC and NR-DC, SRB3 can be used for measurement configuration and reporting, for UE assistance (re-) configuration and reporting for power savings, for IP address (re-) configuration and reporting for IAB-nodes, to (re-) configure MAC, RLC, BAP, physical layer and RLF timers and constants of the SCG configuration, and to reconfigure PDCP for DRBs associated with the S-K_{gNB} or SRB3, and to reconfigure SDAP for DRBs associated with S-K_{gNB} in NGEN-DC and NR-DC, and to add/modify/release conditional PSCell change configuration, provided that the (re-) configuration does not require any MN involvement, and to transmit RRC messages between the MN and the UE during fast MCG link recovery. In (NG) EN-DC and NR-DC, only measConfig, radioBearerConfig, conditionalReconfiguration, bap-Config, iab-IP-AddressConfigurationList, otherConfig and/or secondaryCellGroup are included in RRCReconfiguration received via SRB3, except when RRCReconfiguration is received within DLInformationTransferMRDC.

### Initiation.

The Network may initiate the RRC reconfiguration procedure to a UE in RRC_CONNECTED. The Network applies the procedure as follows:
the establishment of RBs (other than SRB1, that is established during RRC connection establishment) is performed only when AS security has been activated;
the establishment of BH RLC Channels for integrated access and backhaul (IAB) is performed only when AS security has been activated;
the establishment of Uu Relay RLC channels and PC5 Relay RLC channels (other than SL-RLC0 and SL-RLC1) for L2 U2N Relay UE is performed only when AS security has been activated, and the establishment of PC5 Relay RLC channels for L2 U2N Remote UE (other than SL-RLC0 and SL-RLC1) is performed only when AS security has been activated;
the addition of Secondary Cell Group and SCells is performed only when AS security has been activated;
the reconfigurationWithSync is included in secondaryCellGroup only when at least one RLC bearer or BH RLC channel is setup in SCG;
the reconfigurationWithSync is included in masterCellGroup only when AS security has been activated, and SRB2 with at least one DRB or multicast MRB or, for IAB, SRB2, are setup and not suspended;
the conditionalReconfiguration for conditional PSCell change (CPC) is included only when at least one RLC bearer is setup in SCG;
the conditionalReconfiguration for conditional handover (CHO) or conditional PSCell addition (CPA) is included only when AS security has been activated, and SRB2 with at least one DRB or multicast MRB or, for IAB, SRB2, are setup and not suspended.
the ltm-CandidateConfig (LTM candidate cell configuration) for LTM is included only when AS security has been activated, and SRB2 with at least one DRB are setup and not suspended.

### Reception of an RRCReconfiguration by the UE.

The UE shall perform the following actions upon reception of the RRCReconfiguration, or upon execution of the conditional reconfiguration (conditional handover (CHO), conditional PSCell addition (CPA) or conditional PSCell change (CPC)):

For LTM cell switch, how to generate the RRCReconfigurationComplete message is set out in the following.
Option 1. The RRCReconfigurationComplete message is generated upon the reception of LTM triggering MAC CE (or LTM cell switch execution) and then is sent to the target cell during LTM cell switch procedure (e.g. by Message 3 if random access procedure is performed or uplink data transmission if random access procedure is skipped (or not performed, i.e. RACH-less case). This Option 1 makes UE implementation simple because UE cannot know to which cell UE will perform LTM cell switch in advance.

NOTE: To reduce the processing delay for generation of RRCReconfiguration complete, UE may generate the RRCReconfigurationComplete message for each LTM candidate cell configuration upon the reception of RRCReconfiguration message including the ltm-CandidateConfig (LTM candidate cell configuration) in advance, i.e. UE can decide to send one of RRCReconfiguationComplete messages based on the received LTM triggering MAC CE in MAC entity for LTM cell switch procedure.
1> if the LTM cell switch is triggered from lower layers (e.g. by receiving the LTM triggering MAC CE in MAC entity or LTM cell switch execution):
2> set the content of the RRCReconfigurationComplete message as follows:
3> include the LTM candidate cell configuration/information (e.g. cell identity or UE identity or configuration index or configuration identity) for the target cell indicated from lower layers (e.g. as indicated by LTM triggering MAC CE)

NOTE: In case this procedure is initiated due to the generation of a complete LTM candidate cell configuration, the UE should generate only one RRCReconfigurationComplete message even if it process the LTM reference configuration and a LTM candidate cell configuration. The RRCReconfigurationComplete message includes the contents for the target cell indicated by LTM triggering MAC CE.
1> if the RRCReconfiguration message includes the ltm-Candidate Config (LTM candidate cell configuration):
2> perform the LTM configuration procedure as specified in 3.3.1.3;
1> set the content of the RRCReconfigurationComplete message as follows if the RRCReconfiguration message does not include the ltm-CandidateConfig (LTM candidate cell configuration):

NOTE: In case this procedure is initiated due to the generation of a complete LTM candidate cell configuration, the UE should generate only one RRCReconfigurationComplete message even if it process the LTM reference configuration and a LTM candidate cell configuration. The RRCReconfigurationComplete message includes the contents for the target cell indicated by LTM triggering MAC CE.
2> if the RRCReconfiguration includes the masterCellGroup containing the reportUplinkTxDirectCurrent:
3> include the uplinkTxDirectCurrentList for each MCG serving cell with UL;
3> include uplinkDirectCurrentBWP-SUL for each MCG serving cell configured with SUL carrier, if any, within the uplinkTxDirectCurrentList;
2> if the RRCReconfiguration includes the masterCellGroup containing the reportUplinkTxDirectCurrentTwoCarrier;
3> include in the uplinkTxDirectCurrentTwoCarrierList the list of uplink Tx DC locations for the configured intra-band uplink carrier aggregation in the MCG;
2> if the RRCReconfiguration includes the masterCellGroup containing the reportUplinkTxDirectCurrentMoreCarrier:
3> include in the uplinkTxDirectCurrentMoreCarrierList the list of uplink Tx DC locations for the configured intra-band uplink carrier aggregation in the MCG;
2> if the RRCReconfiguration includes the secondaryCellGroup containing the reportUplinkTxDirectCurrent:
3> include the uplinkTxDirectCurrentList for each SCG serving cell with UL;
3> include uplinkDirectCurrentBWP-SUL for each SCG serving cell configured with SUL carrier, if any, within the uplinkTxDirectCurrentList;
2> if the RRCReconfiguration includes the secondaryCellGroup containing the reportUplinkTxDirectCurrentTwoCarrier:
3> include in the uplinkTxDirectCurrentTwoCarrierList the list of uplink Tx DC locations for the configured intra-band uplink carrier aggregation in the SCG;
2> if the RRCReconfiguration includes the secondaryCellGroup containing the reportUplinkTxDirectCurrentMoreCarrier:
3> include in the uplinkTxDirectCurrentMoreCarrierList the list of uplink Tx DC locations for the configured intra-band uplink carrier aggregation in the SCG;

NOTE 0b: The UE does not expect that the reportUplinkTxDirectCurrentTwoCarrier or reportUplinkTxDirectCurrentMoreCarrier is received in both masterCellGroup and in secondaryCellGroup. Network only configures at most one of reportUplinkTxDirectCurrent, reportUplinkTxDirectCurrentTwoCarrier or reportUplinkTxDirectCurrentMoreCarrier in one RRC message.
2> if the RRCReconfiguration message includes the mrdc-SecondaryCellGroupConfig with mrdc-SecondaryCellGroup set to eutra-SCG:
3> include in the eutra-SCG-Response the E-UTRA RRCConnectionReconfigurationComplete message in accordance with TS 36.331 clause 5.3.5.3;
2> if the RRCReconfiguration message includes the mrdc-SecondaryCellGroupConfig with mrdc-SecondaryCellGroup set to nr-SCG:
3> include in the nr-SCG-Response the SCG RRCReconfigurationComplete message;
3> if the RRCReconfiguration message is applied due to conditional reconfiguration execution and the RRCReconfiguration message does not include the reconfigurationWithSync in the masterCellGroup:
4> include in the selectedCondRRCReconfig the condReconfigId for the selected cell of conditional reconfiguration execution;
2> if the RRCReconfiguration includes the reconfigurationWithSync in spCellConfig of an MCG:
3> if the UE has logged measurements available for NR and if the RPLMN is included in plmn-IdentityList stored in VarLogMeasReport:
4> include the logMeasAvailable in the RRCReconfiguration Complete message;
4> if Bluetooth measurement results are included in the logged measurements the UE has available for NR:
5> include the logMeasAvailableBT in the RRCReconfiguration Complete message;
4> if WLAN measurement results are included in the logged measurements the UE has available for NR:
5> include the logMeasAvailableWLAN in the RRCReconfiguration Complete message;
3> if the sigLoggedMeasType in VarLogMeasReport is included:
4> if T330 timer is running and the logged measurements configuration is for NR:
5> set sigLogMeasConfigAvailable to true in the RRCReconfigurationComplete message;
4> else:
5> if the UE has logged measurements available for NR:
6> set sigLogMeasConfigAvailable to false in the RRCReconfiguration Complete message;
3> if the UE has connection establishment failure or connection resume failure information available in VarConnEstFailReport or VarConnEstFailReportList and if the RPLMN is equal to plmn-Identity stored in VarConnEstFailReport or in at least one of the entries of VarConnEstFailReportList:
4> include connEstFailInfoAvailable in the RRCReconfiguration Complete message;
3> if the UE has radio link failure or handover failure information available in VarRLF-Report and if the RPLMN is included in plmn-IdentityList stored in VarRLF-Report; or
3> if the UE has radio link failure or handover failure information available in VarRLF-Report of TS 36.331 and if the UE is capable of cross-RAT RLF reporting and if the RPLMN is included in plmn-IdentityList stored in VarRLF-Report of TS 36.331 [10]:
4> include rlf-InfoAvailable in the RRCReconfigurationComplete message;
3> if the UE was configured with successHO-Config when connected to the source Pcell; and
3> if the applied RRCReconfiguration is not due to a conditional reconfiguration execution upon cell selection performed while timer T311 was running, as defined in 5.3.7.3:
4> perform the actions for the successful handover report determination as specified in clause 5.7.10.6, upon successfully completing the Random Access procedure triggered for the reconfigurationWithSync in spCellConfig of the MCG;
3> if the UE has successful handover information available in VarSuccessHO-Report and if the RPLMN is included in plmn-IdentityList stored in VarSuccessHO-Report:
4> include successHO-InfoAvailable in the RRCReconfiguration Complete message;
2> if the RRCReconfiguration message was received via SRB1, but not within mrdc-SecondaryCellGroup or E-UTRA RRCConnectionReconfiguration or E-UTRA RRCConnectionResume:
3> if the UE is configured to provide the measurement gap requirement information of NR target bands:
4> if the RRCReconfiguration message includes the needForGapsConfigNR; or
4> if the NeedForGapsInfoNR information is changed compared to last time the UE reported this information:
5> include the NeedForGapsInfoNR and set the contents as follows:
6> include intraFreq-needForGap and set the gap requirement information of intra-frequency measurement for each NR serving cell;
6> if requestedTargetBandFilterNR is configured:
7> for each supported NR band that is also included in requestedTargetBandFilterNR, include an entry in interFreq-needForGap and set the gap requirement information for that band;
6> else:
7> include an entry in interFreq-needForGap and set the corresponding gap requirement information for each supported NR band;
3> if the UE is configured to provide the measurement gap and NCSG requirement information of NR target bands:
4> if the RRCReconfiguration message includes the needForGapNCSG-ConfigNR; or
4> if the needForGapNCSG-InfoNR information is changed compared to last time the UE reported this information:
5> include the NeedForGapNCSG-InfoNR and set the contents as follows:
6> include intraFreq-needForNCSG and set the gap and NCSG requirement information of intra-frequency measurement for each NR serving cell;
6> if requestedTargetBandFilterNCSG-NR is configured:
7> for each supported NR band included in requestedTargetBandFilterNCSG-NR, include an entry in interFreq-needForNCSG and set the NCSG requirement information for that band;
6> else:
7> include an entry for each supported NR band in interFreq-needForNCSG and set the corresponding NCSG requirement information;
3> if the UE is configured to provide the measurement gap and NCSG requirement information of E-UTRA target bands:
4> if the RRCReconfiguration message includes the needForGapNCSG-ConfigEUTRA; or
4> if the needForGapNCSG-InfoEUTRA information is changed compared to last time the UE reported this information:
5> include the NeedForGapNCSG-InfoEUTRA and set the contents as follows:
6> if requestedTargetBandFilterNCSG-EUTRA is configured, for each supported E-UTRA band included in requestedTargetBandFilterNCSG-EUTRA, include an entry in needForNCSG-EUTRA and set the NCSG requirement information for that band; otherwise, include an entry for each supported E-UTRA band in needForNCSG-EUTRA and set the corresponding NCSG requirement information;
2> if this procedure is initiated due to the generation of a complete LTM candidate cell configuration:
3> the procedure ends.
Option 2. Upon the reception of RRCReconfiguation, RRCReconfiguationComplete is generated corresponding to the RRCReconfiguration, and sent to the source cell (serving cell or the current cell UE received the RRCReconfiguration from). Another RRCReconfigurationComplete message is generated upon the reception of LTM triggering MAC CE (or LTM cell switch execution) and then is sent to the target cell during LTM cell switch procedure (e.g. by Message 3 if random access procedure is performed or uplink data transmission if random access procedure is skipped (or not performed, i.e. RACH-less case).

This Option 2 has the network know the successful delivery of RRCReconfiguration and makes UE implementation simple because UE cannot know to which cell UE will perform LTM cell switch in advance.

NOTE: To reduce the processing delay for generation of RRCReconfiguration complete, UE may generate the RRCReconfigurationComplete message for each LTM candidate cell configuration upon the reception of RRCReconfiguration message including the ltm-CandidateConfig (LTM candidate cell configuration) in advance, i.e. UE can decide to send one of RRCReconfiguationComplete messages based on the received LTM triggering MAC CE in MAC entity for LTM cell switch procedure.
if the LTM cell switch is triggered from lower layers (e.g. by receiving the LTM triggering MAC CE in MAC entity or LTM cell switch execution):
2> set the content of the RRCReconfigurationComplete message as follows:
3> include the LTM candidate cell configuration/information (e.g. cell identity or UE identity or configuration index or configuration identity) for the target cell indicated from lower layers (e.g. as indicated by LTM triggering MAC CE)

NOTE: In case this procedure is initiated due to the generation of a complete LTM candidate cell configuration, the UE should generate only one RRCReconfigurationComplete message even if it process the LTM reference configuration and a LTM candidate cell configuration. The RRCReconfigurationComplete message includes the contents for the target cell indicated by LTM triggering MAC CE.
1> if the RRCReconfiguration message includes the ltm-Candidate Config (LTM candidate cell configuration):
2> perform the LTM configuration procedure as specified in 3.3.1.3;
1> set the content of the RRCReconfigurationComplete message as follows:

NOTE: In case this procedure is initiated due to the generation of a complete LTM candidate cell configuration, the UE should generate only one RRCReconfigurationComplete message even if it process the LTM reference a configuration and LTM candidate cell configuration. The RRCReconfigurationComplete message includes the contents for the target cell indicated by LTM triggering MAC CE.
2> if the RRCReconfiguration includes the masterCellGroup containing the reportUplinkTxDirectCurrent:
3> include the uplinkTxDirectCurrentList for each MCG serving cell with UL;
3> include uplinkDirectCurrentBWP-SUL for each MCG serving cell configured with SUL carrier, if any, within the uplinkTxDirectCurrentList;
2> if the RRCReconfiguration includes the masterCellGroup containing the reportUplinkTxDirectCurrentTwoCarrier:
3> include in the uplinkTxDirectCurrentTwoCarrierList the list of uplink Tx DC locations for the configured intra-band uplink carrier aggregation in the MCG;
2> if the RRCReconfiguration includes the masterCellGroup containing the reportUplinkTxDirectCurrentMoreCarrier:
3> include in the uplinkTxDirectCurrentMoreCarrierList the list of uplink Tx DC locations for the configured intra-band uplink carrier aggregation in the MCG;
2> if the RRCReconfiguration includes the secondaryCellGroup containing the reportUplinkTxDirectCurrent:
3> include the uplinkTxDirectCurrentList for each SCG serving cell with UL;
3> include uplinkDirectCurrentBWP-SUL for each SCG serving cell configured with SUL carrier, if any, within the uplinkTxDirectCurrentList;
2> if the RRCReconfiguration includes the secondaryCellGroup containing the reportUplinkTxDirectCurrentTwoCarrier:
3> include in the uplinkTxDirectCurrentTwoCarrierList the list of uplink Tx DC locations for the configured intra-band uplink carrier aggregation in the SCG;
2> if the RRCReconfiguration includes the secondaryCellGroup containing the reportUplinkTxDirectCurrentMoreCarrier:
3> include in the uplinkTxDirectCurrentMoreCarrierList the list of uplink Tx DC locations for the configured intra-band uplink carrier aggregation in the SCG;

NOTE 0b: The UE does not expect that the reportUplinkTxDirectCurrentTwoCarrier or reportUplinkTxDirectCurrentMoreCarrier is received in both masterCellGroup and in secondaryCellGroup. Network only configures at most one of reportUplinkTxDirectCurrent, reportUplinkTxDirectCurrentTwoCarrier or reportUplinkTxDirectCurrentMoreCarrier in one RRC message.
2> if the RRCReconfiguration message includes the mrdc-SecondaryCellGroupConfig with mrdc-SecondaryCellGroup set to eutra-SCG:
3> include in the eutra-SCG-Response the E-UTRA RRCConnectionReconfigurationComplete message in accordance with TS 36.331 clause 5.3.5.3;
2> if the RRCReconfiguration message includes the mrdc-SecondaryCellGroupConfig with mrdc-SecondaryCellGroup set to nr-SCG:
3> include in the nr-SCG-Response the SCG RRCReconfiguration Complete message;
3> if the RRCReconfiguration message is applied due to conditional reconfiguration execution and the RRCReconfiguration message does not include the reconfigurationWithSync in the masterCellGroup:
4> include in the selectedCondRRCReconfig the condReconfigId for the selected cell of conditional reconfiguration execution;
2> if the RRCReconfiguration includes the reconfigurationWithSync in spCellConfig of an MCG:
3> if the UE has logged measurements available for NR and if the RPLMN is included in plmn-IdentityList stored in VarLogMeasReport:
4> include the logMeasAvailable in the RRCReconfiguration Complete message;
4> if Bluetooth measurement results are included in the logged measurements the UE has available for NR:
5> include the logMeasAvailableBT in the RRCReconfiguration Complete message;
4> if WLAN measurement results are included in the logged measurements the UE has available for NR:
5> include the logMeasAvailable WLAN in the RRCReconfiguration Complete message;
3> if the sigLoggedMeasType in VarLogMeasReport is included:
4> if T330 timer is running and the logged measurements configuration is for NR:
5> set sigLogMeasConfigAvailable to true in the RRCReconfiguration Complete message;
4> else:
5> if the UE has logged measurements available for NR:
6> set sigLogMeasConfigAvailable to false in the RRCReconfiguration Complete message;
3> if the UE has connection establishment failure or connection resume failure information available in VarConnEstFailReport or VarConnEstFailReportList and if the RPLMN is equal to plmn-Identity stored in VarConnEstFailReport or in at least one of the entries of VarConnEstFailReportList:
4> include connEstFailInfoAvailable in the RRCReconfiguration Complete message;
3> if the UE has radio link failure or handover failure information available in VarRLF-Report and if the RPLMN is included in plmn-IdentityList stored in VarRLF-Report; or
3> if the UE has radio link failure or handover failure information available in VarRLF-Report of TS 36.331 and if the UE is capable of cross-RAT RLF reporting and if the RPLMN is included in plmn-IdentityList stored in VarRLF-Report of TS 36.331 [10]:
4> include rlf-InfoAvailable in the RRCReconfigurationComplete message;
3> if the UE was configured with successHO-Config when connected to the source Pcell; and
3> if the applied RRCReconfiguration is not due to a conditional reconfiguration execution upon cell selection performed while timer T311 was running, as defined in 5.3.7.3:
4> perform the actions for the successful handover report determination as specified in clause 5.7.10.6, upon successfully completing the Random Access procedure triggered for the reconfigurationWithSync in spCellConfig of the MCG;
3> if the UE has successful handover information available in VarSuccessHO-Report and if the RPLMN is included in plmn-IdentityList stored in VarSuccessHO-Report:
4> include successHO-InfoAvailable in the RRCReconfiguration Complete message;
2> if the RRCReconfiguration message was received via SRB1, but not within mrdc-SecondaryCellGroup or E-UTRA RRCConnectionReconfiguration or E-UTRA RRCConnectionResume:
3> if the UE is configured to provide the measurement gap requirement information of NR target bands:
4> if the RRCReconfiguration message includes the needForGapsConfigNR; or
4> if the NeedForGapsInfoNR information is changed compared to last time the UE reported this information:
5> include the NeedForGapsInfoNR and set the contents as follows:
6> include intraFreq-needForGap and set the gap requirement information of intra-frequency measurement for each NR serving cell;
6> if requestedTargetBandFilterNR is configured:
7> for each supported NR band that is also included in requestedTargetBandFilterNR, include an entry in interFreq-needForGap and set the gap requirement information for that band;
6> else:
7> include an entry in interFreq-needForGap and set the corresponding gap requirement information for each supported NR band;
3> if the UE is configured to provide the measurement gap and NCSG requirement information of NR target bands:
4> if the RRCReconfiguration message includes the needForGapNCSG-ConfigNR; or
4> if the needForGapNCSG-InfoNR information is changed compared to last time the UE reported this information:
5> include the NeedForGapNCSG-InfoNR and set the contents as follows:
6> include intraFreq-needForNCSG and set the gap and NCSG requirement information of intra-frequency measurement for each NR serving cell;
6> if requestedTargetBandFilterNCSG-NR is configured:
7> for each supported NR band included in requestedTargetBandFilterNCSG-NR, include an entry in interFreq-needForNCSG and set the NCSG requirement information for that band;
6> else:
7> include an entry for each supported NR band in interFreq-needForNCSG and set the corresponding NCSG requirement information;
3> if the UE is configured to provide the measurement gap and NCSG requirement information of E-UTRA target bands:
4> if the RRCReconfiguration message includes the needForGapNCSG-ConfigEUTRA; or
4> if the needForGapNCSG-InfoEUTRA information is changed compared to last time the UE reported this information:
5> include the NeedForGapNCSG-InfoEUTRA and set the contents as follows:
6> if requestedTargetBandFilterNCSG-EUTRA is configured, for each supported E-UTRA band included in requestedTargetBandFilterNCSG-EUTRA, include an entry in needForNCSG-EUTRA and set the NCSG requirement information for that band; otherwise, include an entry for each supported E-UTRA band in needForNCSG-EUTRA and set the corresponding NCSG requirement information;
2> if this procedure is initiated due to the generation of a complete LTM candidate cell configuration:
3> the procedure ends.

### LTM Configuration and Execution.

In this embodiment, the LTM configuration for candidate cells can indicate the reference configuration for LTM candidate cells or the complete configuration for LTM candidate cells. The reference configuration can be the complete configuration or the reference configuration and a LTM candidate-cell specific configuration can be the complete configuration for the LTM candidate cell.

The UE shall perform the following actions based on a received LTM-CandidateConfig IE:
1> store the received ltm-ReferenceConfiguration in VarLTM-Config, if present;
1> if the LTM-CandidateConfig includes the ltm-CandidateToReleaseList:
2> perform the LTM candidate cell release;
1> if the LTM-Candidate Config includes the ltm-CandidateToAddModList:
2> perform the LTM candidate cell addition or reconfiguration;
1> perform the actions to generate a complete LTM configuration;

NOTE: It is up to the UE implementation to postpone the generation of a complete LTM configuration until the executing of an LTM cell switch.

### LTM Candidate Cell Release.

The UE shall:
1> for each ltm-CandidateId in the ltm-CandidateToReleaseList:
2> if the current VarLTM-Config includes an ltm-Candidate with the given ltm-CandidateId:
3> release the ltm-Candidate from VarLTM-Config;

### LTM Candidate Cell Addition/Modification.

The UE shall:
1> for each ltm-CandidateId in the ltm-CandidateToAddModList:
2> if the current VarLTM-Config includes an ltm-Candidate with the given ltm-CandidateId:
3> modify the ltm-Candidate within VarLTM-Config in accordance with the received ltm-Candidate;
2> else:
3> add the received ltm-Candidate to VarLTM-Config.

### Generation of UE LTM Configuration.

The purpose of this procedure is for the UE to generate a complete LTM candidate cell configuration (or LTM candidate cell configuration) for each LTM candidate cell to be stored and the LTM candidate cell configuration for the target cell indicated by lower layers (i.e. as indicated by LTM triggering MAC CE) is applied only when an indication of an LTM cell switch is received by lower layers. During the generation of a complete LTM candidate cell configuration, the current UE configuration shall not be modified.

The UE shall:
1> for each ltm-Candidate in ltm-CandidateConfigList within VarLTM-Config;
2> store the ltm-CandidateId included in ltm-Candidate within VarLTM-UE-Config;
2> if ltm-Candidate includes ltm-ConfigComplete;
3> generate a complete LTM candidate cell configuration for the received ltm-Candidate according to the actions and store it in ue-LTM-Config within VarLTM-UE-Config.
2> else:
3> generate a complete LTM candidate cell configuration by applying ltm-Candidate on top of referenceConfiguration according to the actions and store it in ue-LTM-Config within VarLTM-UE-Config.

### LTM Cell Switch Execution.

Upon the indication by lower layers that an LTM cell switch procedure is triggered, the UE shall:
1> release/clear all current dedicated radio configuration except for the following:
2> if the LTM cell switch is triggered on the MCG:
   the MCG C-RNTI;
   the AS security configurations associated with the master key;
2> else, if the LTM cell switch is triggered on the SCG:
   the SCG C-RNTI;
   the AS security configurations associated with the secondary key;
   the SRB1/SRB2 configurations and DRB configurations as configured by radioBearerConfig or radioBearerConfig2;
   the UE variables VarLTM-Config and VarLTM-UE-Config.
1> release/clear all current common radio configuration;
1> use the default values specified in 9.2.3 for timers T310, T311 and constants N310, N311;
1> apply the default L1 parameter values as specified in corresponding physical layer specifications except for the following:
   parameters for which values are provided in SIB1;
1> apply the value of the newUE-Identity as the C-RNTI for this cell group according to the LTM candidate cell configuration related to the LTM candidate cell configuration identity as received by lower layers;
1> configure lower layers in accordance with the received spCellConfigCommon according to the LTM candidate cell configuration indicated by lower layers;
1> configure lower layers in accordance with the received rach-ConfigDedicated according to the LTM candidate cell configuration indicated by lower layers.
1> configure the PDCP entity for LTM candidate cell configuration indicated by lower layers with state variables continuation for SRBs, and with the same security configuration as the PDCP entity for the source cell group;
1> stop timer T310 for the corresponding SpCell, if running;
1> if this procedure is executed for the MCG:
2> if timer T316 is running;
3> stop timer T316;
1> stop timer T312 for the corresponding SpCell, if running;
1> apply the specified BCCH configuration defined in 9.1.1.1 for the target LTM candidate cell configuration;
1> acquire the MIB of the target SpCell as indicated in the LTM candidate cell configuration indicated by lower layers, if applicable;
1> apply the LTM configuration in UE-LTM-Config within VarLTM-UE-Config related to the LTM candidate cell configuration identity as received by lower layers.
1> submit the RRCReconfigurationComplete message to lower layers for transmission using the new configuration.

The following relates to RRC messages.

In RRCReconfiguration message, each LTM candidate cell configuration (e.g. in CellGroupConfig IE) can include one of the following information
an indicator to indicate whether to perform DL synchronization to candidate/target cell before receiving the cell switch command (MAC CE).
LTM cell switch indicator (or Cell identity), which can indicate UE to perform LTM cell switch to the target cell (the candidate cell indicated by this indicator) upon the reception of RRCReconfiguration message. This can trigger LTM cell switch earlier than MAC CE based LTM Cell switch, i.e. it does not require the network to send MAC CE to UE in order to trigger LTM cell switch.

LTM candidate cell configuration index (or identity) or Cell identity

TCI state(s) or beam information (e.g. beam index, SSB index, etc.)

After LTM cell switch, UE can keep the LTM candidate cell configuration, which allows subsequent LTM cell switch by MAC CE.

When the network triggers a L3-triggered handover (i.e. handover by RRCReconfiguration including reconfigurationWithSync) to UE, UE can release LTM candidate cell configurations automatically (or by RRCReconfiguration) if the handover or random access procedure to the target cell is successfully completed. As the PCell is changed after the handover and the LTM candidate cell configuration becomes not valid anymore, they should be released and can be updated.

### LTM-CandidateConfig

The IE LTM-CandidateConfig is used to provide LTM candidate cell configuration.

LTM-CandidateConfig information element

-- ASNISTART
-- TAG-LTM-CANDIDATECONFIG-START
LTM-CandidateConfig-r18 ::= SEQUENCE {

| | |
|---|---|
| lte-ReferenceConfiguration-r18 | OCTET STRING (CONTAINING |
| RRCReconfiguration), | OPTIONAL, -- Cond FirstLTM-Candidate |
| ltm-CandidateToReleaseList-r18 | LTM-CandidateToReleaseList-r18 |

OPTIONAL, -- Need N

| | |
|---|---|
| ltm-CandidateToAddModList-r18 | LTM-CandidateToAddModList-r18 |

OPTIONAL, -- Need N

| | |
|---|---|
| ltm-CandidateResetL2-List-r18 | SetupRelease { LTM-CandidateResetL2- |
| List-r18 } | OPTIONAL -- Need M |

...
}
LTM-CandidateToReleaseList-r18 ::= SEQUENCE (SIZE (1..maxNrofCellsLTM-r18) ) OF

| | |
|---|---|
| LTM-CandidateId-r18 | OPTIONAL -- Need N |

LTM-CandidateToAddModList-r18 ::= SEQUENCE (SIZE (1..maxNrofCellsLTM-r18) ) OF
LTM-Candidate-r18
LTM-Candidate-r18 ::= SEQUENCE {

| | |
|---|---|
| ltm-CandidateId-r18 | LTM-CandidateId-r18, |
| ltm-Config-r18 | OCTET STRING (CONTAINING |

RRCReconfiguration),

| | |
|---|---|
| ltm-ConfigComplete-r18 | ENUMERATED {true} |

OPTIONAL -- Need R
...
}
LTM-CandidateResetL2-List-r18 ::= SEQUENCE (SIZE (1..maxNrofCellsLTM-r18) ) OF
LTM-CandidateId-r18
-- TAG-LTM-CANDIDATECONFIG-STOP
-- ASN1STOP

LTM-CandidateConfig field descriptions
ltm-Config
This field includes an RRCReconfiguration message used to configure
an LTM candidate cell. This field shall include the CellGroupConfig
IE, and it may also include the RadioBearerConfig IE, and MeasConfig IE.
ltm-ConfigComplete
This field indicates whether the LTM candidate cell configuration
within ltm-Config is a complete configuration and thus the UE shall
not use the LTM reference configuration within the field lte-
ReferenceConfiguration.
ltm-CandidateNoResetL2-List
This field includes a list of LTM candidate cell identifiers for
which the full L2 reset is needed upon an LTM cell switch.
ltm-ReferenceConfiguration
This field includes an RRCReconfiguration message used to configure
a reference configuration for LTM.

| Conditional | |
|---|---|
| Presence | Explanation |
| FirstLTM-Candidate | This field is mandatory present upon the first |
| | configuration of LTM-CandidateConfig. Otherwise, |
| | the field is optionally present, Need M. |

The following relates to MAC Protocol.

### MAC Control Elements (MAC CEs).

The first MAC CE is LTM triggering MAC CE that triggers cell switch to the target cell (i.e. one of LTM candidate cells configured by RRCReconfiguration message)

The contents of LTM triggering MAC CE (or LTM command MAC CE or LTM MAC CE) can includes one of the following information:
CFRA resources
LTM candidate cell configuration index (or identity) or Cell identity
Cell identity
TCI state(s) or beam information (e.g. beam index, SSB index, etc.)
Timing Advance value (TA value or Timing Advance Command)

Specifically, the first MAC CE (i.e. LTM Command MAC CE) is identified by MAC subheader with eLCID. It has a variable size with one or more of the following fields:
R: Reserved bit, set to 0;
Target Configuration ID (identity) (or Target LTM candidate cell identity (i.e. LTM target cell) or Serving cell identity): This field indicates the index (or identity) of target LTM candidate cell configuration (in RRC configuration) to apply for LTM cell switch, This field can be replaced by a bitmap described earlier in relation to the PDCCH DCI format to indicate the target LTM candidate cell;
Timing Advance Command: To make UE implementation efficient or save the radio resource, several options are provided for this field. One of the options can be implemented.
Option 1: In this option, the Timing Advance Command field (or value) is optional in the first MAC CE (LTM Command MAC CE), which saves the radio resource. This field indicates a value used to control the amount of timing adjustment that the MAC entity has to apply (or it can indicate to use the same TA value of the current serving cell). The UE can skip the Random Access procedure for this LTM cell switch if this field indicates a value (i.e. this field is present or included) or if timeAlignmentTimer (TAT) for the target/indicated LTM candidate cell (or PTAG) is running (i.e. TA value is valid) or if Beam failure is not detected for the target LTM candidate cell (i.e. if BFI_COUNTER<beamFailureInstanceMaxCount for the target/indicated LTM candidate cell (the number of Beam failure Indication is smaller than the maximum number for beam failure detection). UE can indicate to upper layers that a Random Access Procedure is needed for this LTM cell switch or the target LTM candidate cell (or the indicated LTM candidate cell) if Timing Advance Command value is absent (or not included or not present) or if timeAlignmentTimer (TAT) for the target/indicated LTM candidate cell (or PTAG) is not running (i.e. TA value is not valid) or if Beam failure is detected for the target/indicated LTM candidate cell (i.e. if BFI_COUNTER>=beamFailureInstanceMaxCount for the target/indicated LTM candidate cell (or PTAG) (the number of Beam failure Indication is larger than or equal to the maximum number for beam failure detection).
Option 2: In this option, the Timing Advance Command field (or value) is always present in the first MAC CE (LTM Command MAC CE), which eases UE implementation. This field indicates whether the TA is valid for the LTM target cell (i.e. the LTM candidate cell corresponding to the LTM candidate cell configuration (RRC configuration) indicated by Target Configuration ID field) (or whether to use the same TA value of the current serving cell). If the value of this field is set to a special value (e.g. all 0's or all 1's), this field indicates that no valid timing adjustment is available for the PTAG of the LTM target cell. UE shall perform Random Access to the LTM target cell if the value of this field is set to a special value (e.g. all 0's or all 1's); Otherwise, this field indicates a value used to control the amount of timing adjustment that the MAC entity has to apply. The UE can skip the Random Access procedure for this LTM cell switch if this field indicates a value (i.e. this field does not indicate the special value) or if timeAlignmentTimer (TAT) for the target/indicated LTM candidate cell (or PTAG) is running (i.e. TA value is valid) or if Beam failure is not detected for the target LTM candidate cell (i.e. if BFI_COUNTER<beamFailureInstanceMaxCount for the target/indicated LTM candidate cell (the number of Beam failure Indication is smaller than the maximum number for beam failure detection).
TCI state ID: This field indicates or activates the TCI state for the LTM target cell (i.e. the cell (i.e. SpCell) of the target LTM candidate configuration indicated by the Target Configuration ID field). The TCI state is identified by TCI-StateId configured in the target LTM candidate configuration. If this field is absent (or not present or not included), the default TCI state (or the TCI state) configured in the target LTM candidate configuration is used or activated. This field can be replaced or absent by using the fourth MAC CE, i.e., in another embodiment, this field can be indicated/included in the fourth MAC CE.
UL TCI state ID: This field indicates and activates the uplink TCI state for the LTM target cell (i.e. the cell (i.e. SpCell) of the target LTM candidate configuration indicated by the Target Configuration ID field). If this field is absent (or not present or not included), the default TCI state (or the TCI state) configured in the target LTM candidate configuration is used or activated. This field can be replaced or absent by using the fourth MAC CE, i.e., in another embodiment, this field can be indicated/included in the fourth MAC CE.
DL BWP ID: This field indicates the DL BWP that UE uses for the target LTM cell. If this field is present (or included), the MAC entity (or UE) activates the DL BWP indicated by this field for LTM execution or LTM cell switch. If this field is absent (not present or not included), the MAC entity (or UE) activates the DL BWP indicated by RRC configuration (i.e. firstActiveDownlinkBWP-Id in target LTM candidate configuration indicated by the Target Configuration ID) for LTM execution or LTM cell switch. In another embodiment, one common BWP ID (or the same BWP ID) can indicate both DL BWP ID and UL BWP ID or the BWP ID can be indicated/included in the fourth MAC CE.
UL BWP ID: This field indicates the UL BWP that UE uses for the target LTM cell. If this field is present (or included), the MAC entity (or UE) activates the UL BWP indicated by this field for LTM execution or LTM cell switch. If this field is absent (not present or not included), the MAC entity (or UE) activates the UL BWP indicated by RRC configuration (i.e. firstActiveUplinkBWP-Id in target LTM candidate configuration indicated by the Target Configuration ID) for LTM execution or LTM cell switch. In another embodiment, one common BWP ID (or the same BWP ID) can indicate both DL BWP ID and UL BWP ID or the BWP ID can be indicated/included in the fourth MAC CE.

The fields other than Target Configuration ID in this first MAC CE refers to the (target LTM candidate configuration) RRC configuration indicated by the Target Configuration ID field, i.e. The fields are considered (or processed) after the UE has applied the complete (or reference) LTM candidate configuration indicated by Target Configuration ID in the first MAC CE. It does not refer to the RRC configuration in use before/upon reception of this MAC CE.

For the selection of Bandwidth Part (BWP) in LTM cell switch procedure, UE needs to identify the UL BWP of LTM candidate cell for Random Access preamble transmission (on PRACH or RACH). As LTM candidate cell is a non-serving cell and there is no active UL or DL BWP for non-serving cell. UE needs to identify which UL BWP is used by UE for Random Access preamble transmission. With this reason, the UE uses
UL BWP indicated by BWP ID field in the first MAC CE that UE received if the first MAC CE includes BWP ID (e.g. UL BWP ID). The BWP ID is not configured with the same ID as dormant BWP (i.e., dormantBWP-Id).
UL BWP indicated by firstActiveUplinkBWP field in configuration of indicated target LTM candidate cell if the first MAC CE does not include BWP ID (e.g. UL BWP ID). The BWP ID is not configured with the same ID as dormant BWP (i.e., dormantBWP-Id) or the LTM candidate cell configuration does not include dormant BWP configuration (i.e. dormantBWP-Config). In another embodiment, initialUplinkBWP field can be used instead of firstActiveUplinkBWP field.
DL BWP indicated by BWP ID field in the first MAC CE that UE received if the first MAC CE includes BWP ID (e.g. DL BWP ID). The BWP ID is not configured with the same ID as dormant BWP (i.e., dormantBWP-Id).
DL BWP indicated by firstActiveDownlinkBWP field in configuration of indicated target LTM candidate cell if the first MAC CE does not include BWP ID (e.g. DL BWP ID). The BWP ID is not configured with the same ID as dormant BWP (i.e., dormantBWP-Id) or the LTM candidate cell configuration does not include dormant BWP configuration (i.e. dormantBWP-Config). In another embodiment, initialDownlinkBWP field can be used instead of firstActiveUplinkBWP field

Dormant BWP should not be configured for LTM candidate cell(s) as the PDCCH monitoring is required for LTM procedure, e.g. Random Access procedure and LTM Cell switch.

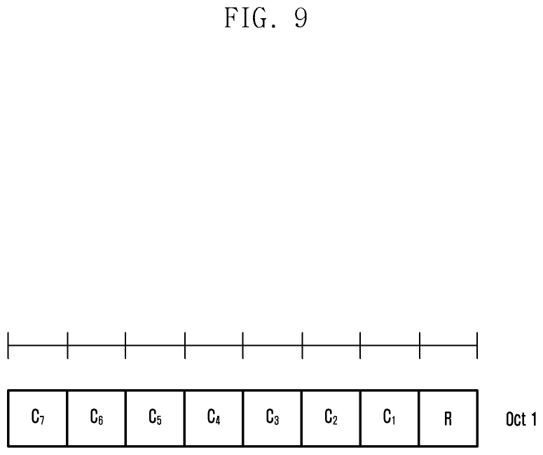

FIG. 9 illustrates SCell Activation/Deactivation MAC CE of one octet according to an embodiment of the disclosure.

The second MAC CE is SCell Activation/Deactivation MAC CE.

The SCell Activation/Deactivation MAC CE of one octet is identified by a MAC subheader with LCID. It has a fixed size and consists of a single octet containing seven C-fields and one R-field. The SCell Activation/Deactivation MAC CE with one octet is defined as follows (FIG. 9).

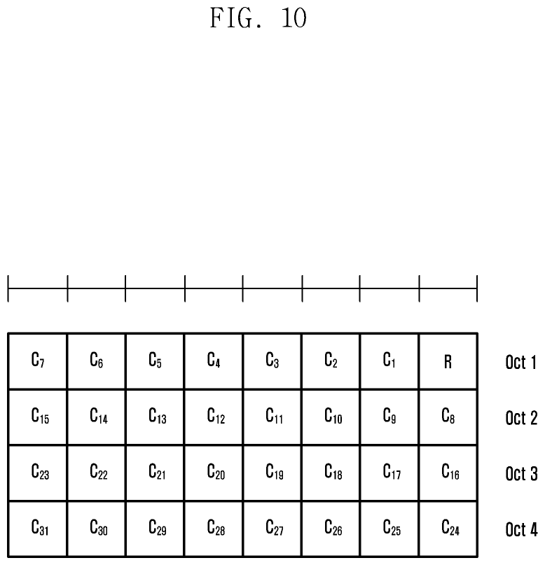

FIG. 10 illustrates SCell Activation/Deactivation MAC CE of four octets according to an embodiment of the disclosure.

The SCell Activation/Deactivation MAC CE of four octets is identified by a MAC subheader with LCID. It has a fixed size and consists of four octets containing 31 C-fields and one R-field. The SCell Activation/Deactivation MAC CE of four octets is defined as follows (FIG. 10).
Cᵢ: If there is an SCell configured for the MAC entity with SCellIndex i as configured in RRC message, this field indicates the activation/deactivation status of the SCell with SCellIndex i, else the MAC entity shall ignore the Cᵢ field. The Cᵢ field is set to 1 to indicate that the SCell with SCellIndex i shall be activated. The Cᵢ field is set to 0 to indicate that the SCell with SCellIndex i shall be deactivated;
R: Reserved bit, set to 0.

NOTE: If UE receives the SCell Activation/Deactivation MAC CE for an SCell configured with TRS for fast activation of the SCell, such TRS is not used for the corresponding SCell.

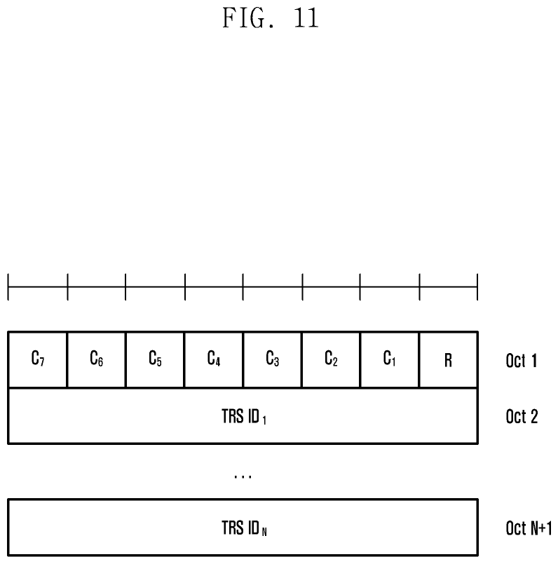

FIG. 11 illustrates Enhanced SCell Activation/Deactivation MAC CE with one octet Ci field according to an embodiment of the disclosure.

The third MAC CE is Enhanced SCell Activation/Deactivation MAC CE.

The Enhanced SCell Activation/Deactivation MAC CE with one octet Cᵢ field is identified by a MAC subheader with eLCID. It has a variable size and consists of seven C-fields, one R-field and zero or more TRS IDⱼ fields in ascending order based on the ScellIndex for SCells indicated by the Cᵢ field(s) to be activated. The Enhanced SCell Activation/Deactivation MAC CE of with one octet Cᵢ field is defined as follows (FIG. 11).

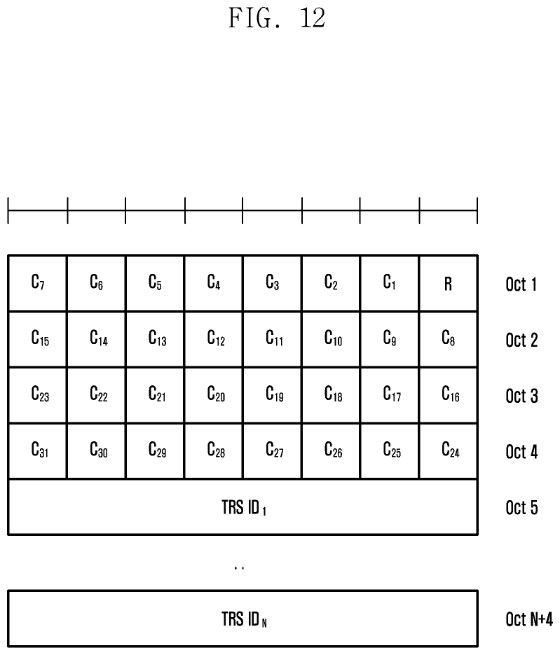

FIG. 12 illustrates Enhanced SCell Activation/Deactivation MAC CE with four octet Ci field according to an embodiment of the disclosure.

The Enhanced SCell Activation/Deactivation MAC CE with four octet Cᵢ field is identified by a MAC subheader with eLCID. It has a variable size and consists of 31 C-fields, one R-field and zero or more TRS IDⱼ fields in ascending order based on the ScellIndex for SCells indicated by the Cᵢ field(s) to be activated. The Enhanced SCell Activation/Deactivation MAC CE with four octet Cᵢ field is defined as follows (FIG. 12).
Cᵢ: If there is an SCell configured for the MAC entity with SCellIndex i as configured in RRC message, this field indicates the activation/deactivation status of the SCell with SCellIndex i, else the MAC entity shall ignore the Cᵢ field. The Cᵢ field is set to 1 to indicate that the SCell with SCellIndex i shall be activated and that a TRS IDⱼ field is included for the SCell. The Cᵢ field is set to 0 to indicate that the SCell with SCellIndex i shall be deactivated and that no TRS ID field is included for this SCell;
TRS IDⱼ: If TRS IDⱼ is set to a non-zero value, it indicates the corresponding TRS address by scellActivationRS-Id as configured in RRC message is activated. If TRS IDⱼ is set to zero, it indicates that no TRS is used for the corresponding SCell;
R: Reserved bit, set to 0.

For the first, second, and third MAC CEs, the following rules and restrictions are provided to make UE behavior for LTM cell switch procedure simple and efficient. As described in Section 2.1 earlier, LTM supports both intra-gNB-DU and intra-gNB-CU inter-gNB-DU mobility. LTM also supports inter-frequency mobility, including mobility to inter-frequency cell that is not a current serving cell. The following scenarios are supported:
PCell change in non-CA scenario,
PCell change without SCell change in CA scenario,
PCell change with SCell change(s) in CA scenario, including the following cases:
a) The target PCell/target SCell(s) is not a current serving cell (CA-to-CA scenario with PCell change)
b) The target PCell is a current SCell
c) The target SCell is the current PCell.

To support these scenarios efficiently, some rules and restrictions for the MAC CEs may need to be defined because some scenarios cause complexity in UE implementation. For example, the current PCell can be indicated LTM cell switch to one of the current SCells and be indicated SCell activation/deactivation, which would be a sort of race conditions.
Option 1. In this option, the network should not send the first MAC CE together with the second MAC CE (or the third MAC CE) to UE. In other words, the network should not include the first MAC CE and the second MAC CE (or the third MAC CE) in the same MAC PDU. By having this restriction, the network can send the commands stage by stage. For example,
Step 1: The network can configure LTM candidate cell configuration to UE by RRC message. The network can activate or deactivate or configure (add/modify) or release SCells by RRC message or the second MAC CE or the third MAC CE to get SCells ready for LTM cell switch by activating/deactivating SCells, which may be done with LTM candidate cell configuration at the same time, i.e. by RRC message or MAC CE.
Step 2: The network can send the first MAC CE to UE in order to trigger LTM cell switch to the target cell.
Step 3: The network can send the second MAC CE or the third MAC CE to UE to activate or deactivate SCells (e.g. after the successful completion of LTM cell switch or when the condition is met as set out earlier)
Option 2. In this option, the network can send the first MAC CE together with the second MAC CE (or the third MAC CE) to UE. In other words, the network can include the first MAC CE and the second MAC CE (or the third MAC CE) in the same MAC PDU. By allowing this, the network can send the commands (LTM cell switch and SCell activation/deactivation) altogether, which can reduce the delay. For example,
Step 1: The network can configure LTM candidate cell configuration to UE by RRC message. The network may activate or deactivate or configure (add/modify) or release SCells by RRC message or the second MAC CE or the third MAC CE to get SCells ready for LTM cell switch by activating/deactivating SCells, which may be done with LTM candidate cell configuration at the same time, i.e. by RRC message or MAC CE. It can be also done by including the first MAC CE and the second MAC CE (or the third MAC CE) in the same MAC PDU in Step 2.
Step 2: The network can send the first MAC CE to UE in order to trigger LTM cell switch to the target cell. Or the network can send the first MAC CE and the second MAC CE (or the third MAC CE) together to UE in the same MAC PDU to trigger LTM cell switch and SCell activation/deactivation.

To ease UE implementation, UE can automatically deactivate or de-configure SCells upon the reception of the first MAC CE (or upon LTM execution) or upon the reception of RRC Reconfiguration including LTM candidate configurations or upon/after the application of the target LTM candidate configuration. In another embodiment, UE can activate or deactivate or de-configure or configure SCells according to the target LTM candidate configuration (or by the second (or the third) MAC CE) for LTM execution procedure, i.e. the network can decide the state of SCells by RRC message or MAC CE. In another embodiment, UE can automatically deactivate or de-configure SCells belonging to the PTAG (i.e. the SCells with the same TA value as SpCell (Serving Cell)) upon the reception of the first MAC CE (or upon LTM execution) or upon the reception of RRC Reconfiguration including LTM candidate configurations or upon/after the application of the target LTM candidate configuration. In another embodiment, UE can deactivate or de-configure SCells belonging to the PTAG (i.e. the SCells with the same TA value as SpCell (Serving Cell)) according to the target LTM candidate configuration (or by the second (or the third) MAC CE) for LTM execution procedure, i.e. the network can decide the state of SCells by RRC message or MAC CE.

For Option 2, the network can construct MAC PDU for downlink as follows:

A MAC PDU consists of one or more MAC subPDUs. Each MAC subPDU consists of one of the following:
A MAC subheader only (including padding);
A MAC subheader and a MAC SDU;
A MAC subheader and a MAC CE;
A MAC subheader and padding.

The MAC SDUs are of variable sizes.

Each MAC subheader corresponds to either a MAC SDU, a MAC CE, or padding.

A MAC subheader except for fixed sized MAC CE, padding, and a MAC SDU containing UL CCCH consists of the header fields R/F/LCID/(eLCID)/L. A MAC subheader for fixed sized MAC CE, padding, and a MAC SDU containing UL CCCH consists of the two header fields R/LCID/(eLCID).

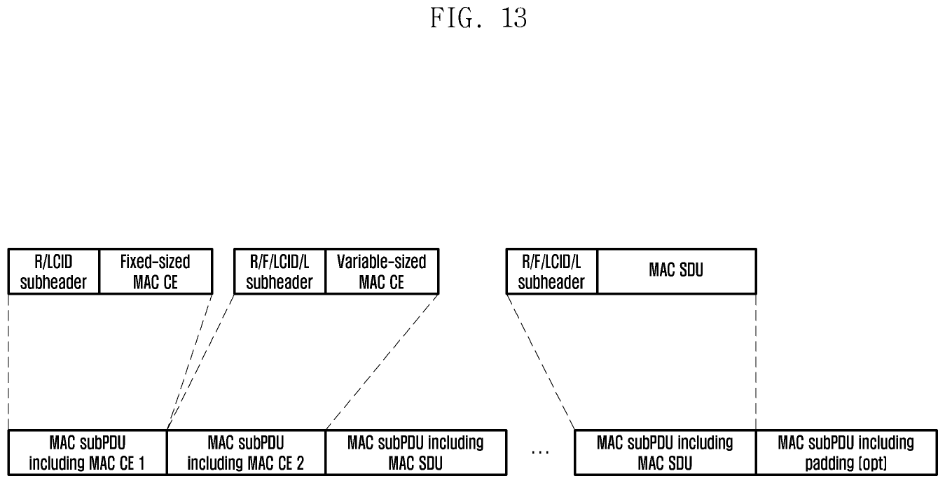

FIG. 13 illustrates an example of a DL MAC PDU according to an embodiment of the disclosure.

MAC CEs are placed together. DL MAC subPDU(s) with MAC CE(s) is placed before any MAC subPDU with MAC SDU and MAC subPDU with padding as depicted in FIG. 13.

Upon the reception of the second MAC CE (or the third MAC CE) and the first MAC CE, UE should first process (or read) the second MAC CE (or the third MAC CE) to get SCells ready for LTM cell switch by activating/deactivating SCells. And then, UE can process (or read) the first MAC CE to trigger LTM cell switch. To make UE processing easier, the order of MAC CEs is defined as the second MAC CE (or the third MAC CE) is placed before the first MAC CE.

In another embodiment, upon the reception of the first MAC CE and the second MAC CE (or the third MAC CE), UE should first process (or read) the first MAC CE to trigger LTM cell switch. And then, UE can process (or read) the second MAC CE (or third MAC CE) to activate/deactivate SCells (e.g. after the successfully completing LTM cell switch according to the above conditions). To make UE processing easier, the order of MAC CEs is defined as the first MAC CE is placed before the second MAC CE (or the third MAC CE). The second MAC CE (or the third MAC CE) may be processed upon/after the successful completion of LTM cell switch (when the above condition is met).

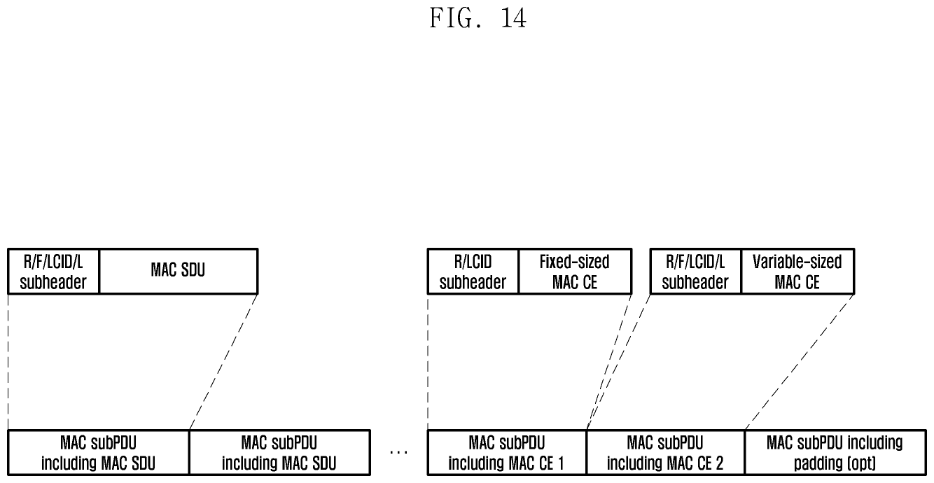

FIG. 14 illustrates an example of a UL MAC PDU according to an embodiment of the disclosure.

UL MAC subPDU(s) with MAC CE(s) is placed after all the MAC subPDU(s) with MAC SDU and before the MAC subPDU with padding in the MAC PDU as depicted in FIG. 14. The size of padding can be zero.

A maximum of one MAC PDU can be transmitted per TB per MAC entity.

With Option 1 or Option 2, LTM supports both intra-gNB-DU and intra-gNB-CU inter-gNB-DU mobility. LTM also supports inter-frequency mobility, including mobility to inter-frequency cell that is not a current serving cell. The following scenarios are supported:
PCell change in non-CA scenario,
PCell change without SCell change in CA scenario,
PCell change with SCell change(s) in CA scenario, including the following cases:
a) The target PCell/target SCell(s) is not a current serving cell (CA-to-CA scenario with PCell change)
b) The target PCell is a current SCell
c) The target SCell is the current PCell.

The fourth MAC CE is LTM Candidate Cell TCI States Activation/Deactivation MAC CE.

The Candidate Cell TCI States Activation/Deactivation MAC CE is identified by a MAC subheader with eLCID as specified in Table 6.2.1-1b. It has a variable size consisting of one or more of following fields:
LTM candidate Configuration ID or Candidate Cell ID: This field indicates the identity of an LTM candidate Cell or LTM candidate Configuration identity for which the MAC CE applies, corresponding to the LTM candidate configuration in RRC reconfiguration. In another embodiment, this field can be replaced (or absent) by Target Configuration ID in the first MAC CE. For example, the fields in the fourth MAC CE can be applied or processed when the first MAC CE is received and the Target Configuration ID is received.
Pᵢ: This field indicates whether each TCI codepoint has multiple TCI states or a single TCI state. If the Pᵢ field is set to 1, the i^{th} TCI codepoint includes the DL TCI state and the UL TCI state. If the Pᵢ field is set to 0, the i^{th} TCI codepoint includes only the DL/joint TCI state or the UL TCI state. The codepoint to which a TCI state is mapped is determined by its ordinal position among all the TCI state ID fields;
D/U: This field indicates whether the TCI state ID in the same octet is for a joint/downlink or an uplink TCI state. If this field is set to 1, the TCI state ID in the same octet is for joint/downlink. If this field is set to 0, the TCI state ID in the same octet is for uplink;
TCI state ID: This field indicates the TCI state identified by TCI-StateId or TCI-UL-StateId in target LTM candidate configuration. If D/U is set to 1, 7-bits length TCI state ID i.e. TCI-StateId configured in target LTM candidate configuration is used. If D/U is set to 0, the most significant bit of TCI state ID is considered as the reserved bit and remaining 6 bits indicate the TCI-UL-StateId configured in target LTM candidate configuration.
DL BWP ID: This field indicates the DL BWP that UE uses for the target LTM cell. If this field is present (or included), the MAC entity (or UE) activates the DL BWP indicated by this field for LTM execution or LTM cell switch. If this field is absent (not present or not included), the MAC entity (or UE) activates the DL BWP indicated by RRC configuration (i.e. firstActiveDownlinkBWP-Id in target LTM candidate configuration indicated by the Target Configuration ID) for LTM execution or LTM cell switch. In another embodiment, one common BWP ID (or the same BWP ID) can indicate both DL BWP ID and UL BWP ID.
UL BWP ID: This field indicates the UL BWP that UE uses for the target LTM cell. If this field is present (or included), the MAC entity (or UE) activates the DL BWP indicated by this field for LTM execution or LTM cell switch. If this field is absent (not present or not included), the MAC entity (or UE) activates the DL BWP indicated by RRC configuration (i.e. firstActiveUplinkBWP-Id in target LTM candidate configuration indicated by the Target Configuration ID) for LTM execution or LTM cell switch. In another embodiment, one common BWP ID (or the same BWP ID) can indicate both DL BWP ID and UL BWP ID.
R: Reserved bit, set to 0.

The fields in this fourth MAC CE refers to the (target LTM candidate configuration) RRC configuration indicated by the Target Configuration ID field in the first MAC CE, i.e. The fields are considered (or processed) after the UE has applied the complete (or reference) LTM candidate configuration indicated by Target Configuration ID in the first MAC CE. It does not refer to the RRC configuration in use before/upon reception of this MAC CE.

The fourth MAC CE can be placed before the first MAC CE when the MAC CEs are included in the same MAC PDU, which enables early TCI state processing. In another embodiment, the fourth MAC CE can be placed after the first MAC CE when the MAC CEs are included in the same MAC PDU, which enables fast application of the indicated LTM candidate cell configuration.

The following relates to Random Access procedure.

When a Random Access procedure is initiated, UE selects a set of Random Access resources and initializes the following parameters for the Random Access procedure according to the values configured by RRC for the selected set of Random Access resources:
preambleReceivedTargetPower: initial Random Access Preamble power for 4-step RA type;
powerRampingStep: the power-ramping factor;
msgA-PreamblePowerRampingStep: the power ramping factor for MSGA preamble;
ra-PreambleIndex: Random Access Preamble;
ra-PreambleStartIndex: the starting index of Random Access Preamble(s) for on-demand SI request;
startPreambleForThisPartition: the first preamble associated with the set of Random Access Resources applicable to the Random Access procedure;
preambleTransMax: the maximum number of Random Access Preamble transmission;

The following UE variables are used for the Random Access procedure:
PREAMBLE_INDEX;
PREAMBLE_TRANSMISSION_COUNTER;
PREAMBLE_TRANSMISSION_COUNTER_LTM;
PREAMBLE_POWER_RAMPING_COUNTER;
PREAMBLE_POWER_RAMPING_COUNTER_LTM;
PREAMBLE_POWER_RAMPING_STEP;
PREAMBLE_RECEIVED_TARGET_POWER;
POWER_OFFSET_2STEP_RA;
MSGA_PREAMBLE_POWER_RAMPING_STEP.

In this disclosure, we support RACH-less solution (i.e. LTM cell switch without Random Access procedure) when UE performs LTM procedure (e.g. LTM execution) by the first MAC CE (i.e. LTM triggering MAC CE described in Section 4.1). In RACH-less procedure, the UE needs a valid TA to send the first UL message during LTM execution procedure (i.e. LTM cell switch). To provide the TA with early RACH procedure (i.e. PDCCH-ordered Random Access procedure before the first MAC CE), PDCCH-ordered Random Access procedure without Random Access Response (RAR) is provided.

When the Random Access procedure for TA acquisition of LTM candidate cell(s) is triggered/indicated by PDCCH order (e.g. by an indication), UE performs Random Access procedure, i.e. UE transmits the preamble to Physical Random Access Channel (PRACH) resource of the indicated LTM candidate cell(s) and complete the Random Access procedure, i.e. the preamble transmission during this Random Access procedure for TA acquisition (i.e. early RACH) can be considered as this Random Access procedure is successfully completed. The preamble or the PRACH resources can be indicated by PDCCH order or (pre-) configured by RRC message (e.g. RRCReconfiguration message). To reduce the processing complexity, the UE does not calculate Radio Network Temporary Identifier (RNTI) for Random Access Response (RA-RNTI) before/when the preamble is transmitted, unlike normal Random Access procedure (RACH). To enable this functionality, one of the following options can be implemented:
Option 1: In this option, the network can avoid another Random access procedure during the Random Access procedures for TA acquisition (i.e. before the successful completion of TA acquisition). The first preamble transmission for TA acquisition may not be successful and the network can request preamble retransmission for TA acquisition. In this case, the UE increments the first variable (PREAMBLE_POWER_RAMPING_COUNTER), calculates the preamble received target power, and retransmit the preamble with the higher power than the first preamble. For example, if the Random Access procedure is not initiated by the PDCCH order for an LTM candidate cell as preamble re-transmission (or if the normal Random Access procedure is initiated or if the Random Access procedure is initiated for LTM execution (i.e. LTM cell switch)), UE sets the first variable to 1. In other words, if the Random Access procedure is initiated by the PDCCH order for an LTM candidate cell as preamble transmission, i.e. first transmission (or if the normal Random Access procedure is initiated or if the Random Access procedure is initiated for LTM execution (i.e. LTM cell switch)), UE sets the first variable to 1. If the Random Access procedure is initiated by the PDCCH order for an LTM candidate cell as preamble re-transmission, UE does not set the first variable to 1. If the Random Access procedure is initiated by the PDCCH order for an LTM candidate cell as preamble re-transmission, UE increments the first variable by 1. Based on this, UE can calculate the preamble received target power, and retransmit the preamble with the higher power than the first preamble. To achieve this, the following procedure can be implemented (the same principle can be applied to other variable (e.g. PREAMBLE_TRANSMISSION_COUNTER):

### (1) Random Access Procedure Initialization

When the Random Access procedure is initiated on a Serving Cell or to an LTM candidate cell (or if the Random Access procedure is initiated for LTM execution (i.e. LTM cell switch) or if the Random Access procedure is initiated for TA acquisition for an LTM candidate cell), the MAC entity shall:
1> flush the Msg3 buffer;
1> flush the MSGA buffer;
1> set the PREAMBLE_TRANSMISSION_COUNTER to 1;
1> set the PREAMBLE_POWER_RAMPING_COUNTER to 1, if the Random Access procedure is not initiated by the PDCCH order for an LTM candidate cell (i.e. for TA acquisition of the cell) as preamble re-transmission;

### (2) Random Access Preamble Transmission

The MAC entity shall, for each Random Access Preamble:
1> if PREAMBLE_TRANSMISSION_COUNTER is greater than one; and
1> if the notification of suspending power ramping counter has not been received from lower layers; and
1> if LBT failure indication was not received from lower layers for the last Random Access Preamble transmission; and
1> if SSB or CSI-RS selected is not changed from the selection in the last Random Access Preamble transmission:
2> increment PREAMBLE_POWER_RAMPING_COUNTER by 1.
1> if the Random Access procedure is initiated by the PDCCH order for an LTM candidate cell (i.e. for TA acquisition of the cell) as preamble re-transmission:
2> increment PREAMBLE_POWER_RAMPING_COUNTER by 1.
1> select the value of DELTA_PREAMBLE;
1> set PREAMBLE_RECEIVED_TARGET_POWER to preambleReceivedTargetPower+DELTA_PREAMBLE+(PREAMBLE_POWER_RAMPING_COUNTER−1)×PREAMBLE_POWER_RAMPING_STEP+POWER_OFFSET_2STEP_RA;
1> except for contention-free Random Access Preamble for beam failure recovery request and Random Access Preamble for an LTM candidate cell by the PDCCH-ordered Random Access procedure (i.e. for TA acquisition of the cell), compute the RA-RNTI associated with the PRACH occasion in which the Random Access Preamble is transmitted; (UE doesn't have to compute the RA-RNTI associated with the PRACH occasion in which the Random Access Preamble is transmitted if Random Access Preamble is transmitted by PDCCH order for TA acquisition of the LTM candidate cell because the reception of RAR is not expected. However, UE computes the RA-RNTI associated with the PRACH occasion in which the Random Access Preamble is transmitted, for normal Random Access procedure or Random Access procedure for LTM execution (i.e. LTM cell switch).
1> instruct the physical layer to transmit the Random Access Preamble using the selected PRACH occasion, corresponding RA-RNTI (if available), PREAMBLE_INDEX, and PREAMBLE_RECEIVED_TARGET_POWER.
1> if the Random Access Procedure is triggered by a PDCCH order for a LTM candidate cell (i.e. for TA acquisition of the cell): (The preamble transmission during this Random Access procedure for TA acquisition (i.e. early RACH) can be considered as this Random Access procedure is successfully completed)
2> consider this Random Access procedure successfully completed (or consider this Random Access Response reception successful);
Option 2: In this option, the network can allow another Random Access procedure during the Random Access procedures for TA acquisition (i.e. before the successful completion of TA acquisition) by introducing the second variable (PREAMBLE_POWER_RAMPING_COUNTER_LTM). It can be also extended to support TA acquisition for multiple LTM candidates by having the second variable per LTM candidate cell. The first preamble transmission for TA acquisition may not be successful and the network can request preamble retransmission for TA acquisition. In this case, the UE increments the second variable, calculates the preamble received target power, and retransmit the preamble with the higher power than the first preamble. For example, if the Random Access procedure is not initiated by the PDCCH order for an LTM candidate cell as preamble re-transmission, UE sets the second variable to 1. In other words, if the Random Access procedure is initiated by the PDCCH order for an LTM candidate cell as preamble transmission, UE sets the second variable to 1. If the Random Access procedure is initiated by the PDCCH order for an LTM candidate cell as preamble re-transmission, UE does not set the second variable to 1. If the Random Access procedure is initiated by the PDCCH order for an LTM candidate cell as preamble re-transmission, UE increments the second variable by 1. Based on this, UE can calculate the preamble received target power, and retransmit the preamble with the higher power than the first preamble. However, if the normal Random Access procedure is initiated or if the Random Access procedure is initiated for LTM execution (i.e. LTM cell switch), UE sets the first variable to 1. In other words, if the normal Random Access procedure is initiated or if the Random Access procedure is initiated for LTM execution (i.e. LTM cell switch), UE sets the first variable to 1. If the Random Access procedure is initiated by the PDCCH order for an LTM candidate cell as preamble re-transmission, UE does not set the first variable to 1. if PREAMBLE_TRANSMISSION_COUNTER is greater than one; and if the notification of suspending power ramping counter has not been received from lower layers; and if LBT failure indication was not received from lower layers for the last Random Access Preamble transmission and if SSB or CSI-RS selected is not changed from the selection in the last Random Access Preamble transmission, UE increments the first variable by 1. Based on this, UE can calculate the preamble received target power, and retransmit the preamble with the higher power than the first preamble. To achieve this, the following procedure can be implemented (the same principle can be applied to other variables (e.g.

PREAMBLE_TRANSMISSION_COUNTER):

### (1) Random Access Procedure Initialization

When the Random Access procedure is initiated on a Serving Cell (or when the Random Access procedure is initiated for LTM execution (i.e. LTM cell switch) (and if the Random Access procedure is not initiated on a Serving Cell towards an LTM candidate cell (for TA acquisition of the LTM candidate cell by a PDCCH order including indications), the MAC entity shall:
1> flush the Msg3 buffer;
1> flush the MSGA buffer;
1> set the PREAMBLE_TRANSMISSION_COUNTER to 1;
1> set the PREAMBLE_POWER_RAMPING_COUNTER to 1;
1> set the PREAMBLE_BACKOFF to 0 ms;

When the Random Access procedure is initiated on a Serving Cell towards an LTM candidate cell (for TA acquisition of the LTM candidate cell by a PDCCH order including indications, e.g. LTM candidate cell identity, TA acquisition, preamble, PRACH resource, etc.), the MAC entity shall:
1> flush the Msg3 buffer;
1> flush the MSGA buffer;
1> set the PREAMBLE_TRANSMISSION_COUNTER_LTM to 1;
1> set the PREAMBLE_POWER_RAMPING_COUNTER_LTM to 1 (or set the PREAMBLE_POWER_RAMPING_COUNTER_LTM for the LTM candidate cell to 1), if the Random Access procedure is not initiated by the PDCCH order for an LTM candidate cell (i.e. for TA acquisition of the cell) as preamble re-transmission; (PREAMBLE_POWER_RAMPING_COUNTER_LTM can be set to 1 if the Random Access procedure is initiated by the PDCCH order for an LTM candidate cell (i.e. for TA acquisition of the cell) as preamble transmission (i.e. first transmission) or if LTM execution is successfully completed or upon the reception of the first MAC CE (i.e. LTM triggered MAC CE).

### (2) Random Access Preamble Transmission

The MAC entity shall, for each Random Access Preamble:
1> if PREAMBLE_TRANSMISSION_COUNTER is greater than one; and
1> if the notification of suspending power ramping counter has not been received from lower layers; and
1> if LBT failure indication was not received from lower layers for the last Random Access Preamble transmission; and
1> if SSB or CSI-RS selected is not changed from the selection in the last Random Access Preamble transmission:
2> increment PREAMBLE_POWER_RAMPING_COUNTER by 1.
1> if the Random Access procedure is initiated by the PDCCH order for an LTM candidate cell (i.e. for TA acquisition of the cell) as preamble re-transmission:
2> increment PREAMBLE_POWER_RAMPING_COUNTER_LTM by 1 (or increment PREAMBLE_POWER_RAMPING_COUNTER_LTM for the LTM candidate cell by 1.
1> select the value of DELTA_PREAMBLE;
1> set PREAMBLE_RECEIVED_TARGET_POWER to preambleReceivedTargetPower+DELTA_PREAMBLE+(PREAMBLE_POWER_RAMPING_COUNTER_LTM 1×PREAMBLE_POWER_RAMPING_STEP+POWER_OFFSET_2STEP_RA, if the Random Access procedure is initiated by the PDCCH order for an LTM candidate cell (i.e. for TA acquisition of the cell);
1> set PREAMBLE_RECEIVED_TARGET_POWER to preambleReceivedTargetPower+DELTA_PREAMBLE+(PREAMBLE_POWER_RAMPING_COUNTER 1)×PREAMBLE_POWER_RAMPING_STEP+POWER_OFFSET_2STEP_RA if the Random Access procedure is not initiated by the PDCCH order for an LTM candidate cell (i.e. for TA acquisition of the cell);
1> except for contention-free Random Access Preamble for beam failure recovery request and Random Access Preamble for an LTM candidate cell by the PDCCH-ordered Random Access procedure (i.e. for TA acquisition of the cell), compute the RA-RNTI associated with the PRACH occasion in which the Random Access Preamble is transmitted; (UE doesn't have to compute the RA-RNTI associated with the PRACH occasion in which the Random Access Preamble is transmitted if Random Access Preamble is transmitted by PDCCH order for TA acquisition of the LTM candidate cell because the reception of RAR is not expected. However, UE computes the RA-RNTI associated with the PRACH occasion in which the Random Access Preamble is transmitted, for normal Random Access procedure or Random Access procedure for LTM execution (i.e. LTM cell switch).
1> instruct the physical layer to transmit the Random Access Preamble using the selected PRACH occasion, corresponding RA-RNTI (if available), PREAMBLE_INDEX, and PREAMBLE_RECEIVED_TARGET_POWER.
1> if the Random Access Procedure is triggered by a PDCCH order for a LTM candidate cell (i.e. for TA acquisition of the cell): (The preamble transmission during this Random Access procedure for TA acquisition (i.e. early RACH) can be considered as this Random Access procedure is successfully completed)
2> consider this Random Access procedure successfully completed (or consider this Random Access Response reception successful);
Option 3: In this option, we can introduce multiple bits in PDCCH order to explicitly indicate the number of preamble (re-)transmission to UE. Specifically, when UE receives PDCCH order indicating Random Access procedure for TA acquisition of LTM candidate cell(s), the multiple bits explicitly indicate a certain value (e.g. the number of preamble (re-)transmission. In this way, the UE can determine the COUNT values of variables for Random Access procedure (e.g. PREAMBLE_POWER_RAMPING_COUNTER or PREAMBLE_TRANSMISSION_COUNTER) from the multiple bits. For example, if the PDCCH has 2 bits for this way, 00 may indicate the first preamble retransmission (i.e. the COUNT value=2), 10 may indicate the third preamble transmission (i.e. the COUNT value=4), 11 may indicate the fourth preamble transmission (i.e. the COUNT value=5). If the PDDCH doesn't include these 2 bits, then it may indicate the first preamble transmission (i.e. not retransmission). It can be extended to the cases with more bits. Such COUNT value can be determined and set to the values of variables for or Random Access procedure (e.g. PREAMBLE_POWER_RAMPING_COUNTER or PREAMBLE_TRANSMISSION_COUNTER).

The contents of the PDCCH order triggering/indicating the Random Access procedure for TA acquisition of LTM candidate cell(s) (i.e. a PRACH transmission on a LTM candidate cell) can be set out in details, e.g. how to use the bits in PDCCH DCI format to indicate the LTM candidate cell. The PDCCH order from the source cell contains the indication of candidate cell. The reserved bit(s) in DCI (Downlink Control Information) format 1_0 for PDCCH order can be used for indication of cell identity. Specifically, for a PRACH transmission by a UE triggered by a PDCCH order, the PRACH mask index field, if the value of the random access preamble index field is not zero, indicates the PRACH occasion for the PRACH transmission where the PRACH occasions are associated with the SS/PBCH block index indicated by the SS/PBCH block index field of the PDCCH order and, if any, a cell indicator field indicates a cell for the PRACH transmission. The PDCCH DCI format also includes a 1-bit field in PDCCH order explicitly indicating initial transmission or retransmission of PRACH.

Several options are provided for a cell indicator and follow one of the options to trigger a Random Access procedure on a LTM candidate cell by PDCCH order, which indicates one of LTM candidate cells configured to UE.
Option 1: In this option, the bits in PDCCH (i.e. in DCI format) indicates Cell identity or Configuration Identity configured for a LTM candidate cell in RRC configuration. It makes UE implementation very simple.
Option 2: In this option, a mapping scheme is provided between the bits in PDCCH and the Cell identity (or Configuration Identity) in RRC configuration (i.e. bitmap) to save bits in PDCCH.

For Option 2, the following bitmap structure in DCI format is provided.
A UE configured with (complete or reference) LTM configuration on the PCell or on the SpCell, the contents in PDCCH DCI format include:
   a bit indicating preamble transmission or retransmission,
   a field indicating the Random Access procedure for TA acquisition of LTM candidate cell(s) (i.e. a PRACH transmission (or retransmission) on a LTM candidate cell) is a bitmap with size equal to a number of configured LTM candidate cells (or configurations) by RRC configuration,
   each bit of the bitmap corresponds to a configured LTM candidate cell (or configuration) from the number of configured LTM candidate cells (or configurations) in an ascending (or descending) order of the cell identity (or configuration identity). This mapping can be done from LSB (Least Significant Bit) or MSB (Most Significant Bit).
   a bitmap, when the UE is provided a number of configured LTM candidate cells (or configurations) by RRC configuration, where
   the bitmap location is immediately after the bit location already used for their own purposes.
   the bitmap size is equal to the number of configured LTM candidate cells (or configurations) where each bit of the bitmap corresponds to a configured LTM candidate cell (or configuration) from the number of configured LTM candidate cells (or configurations)
   a‘1’ value (or ‘0’ value) for a bit of the bitmap indicates a preamble transmission or re-transmission on the corresponding configured LTM candidate cell.
   a ‘0’ value (or ‘1’ value) for a bit of the bitmap indicates no preamble transmission or re-transmission on the corresponding configured LTM candidate cell. UE can ignore this bit.
   When UE detects a ‘1’ value for a bit of the bitmap, UE is not required to detect the later bits to reduce the UE processing burden as they have ‘0’ values, i.e. only one bit can have ‘1’ value in the bitmap.
   For preamble transmission or retransmission, the UE sets the active BWP (e.g. UL BWP) to the indicated active BWP (e.g. UL BWP) in PDCCH or the indicated active BWP (e.g. UL BWP) in RRC configuration (e.g. firstActiveBWP or firstActiveUplinkBWP or defaultBWP or defaultUplinkBWP or initialBWP or initialUplinkBWP)

A UE can be provided RRC configurations for PRACH transmission parameters, e.g. by LTM-CFRA-ToAddModList for LTM candidate cells. The UE can be triggered a PRACH transmission on a cell by a PDCCH order that the UE receives on a serving cell and includes an indication of the cell for the PRACH transmission. The UE transmits the PRACH on the cell. A UE can be provided by a MAC CE in a PDSCH reception on the serving cell, e.g. a TCI-State for uplink or downlink or both (i.e. joint UL/DL, a unified TCI state for applicable receptions or transmissions on a cell from the number of cells). The UE applies the TCI-State and/or TCI-UL-State and/or TCI-DL-State, if indicated by the MAC CE, from a first slot after the last symbol of a PUCCH or PUSCH with HARQ-ACK information for the PDSCH providing the MAC CE.

In embodiments of this disclosure, the LTM procedures (e.g. LTM execution, Random Access procedure for TA acquisition of LTM candidate cell(s) (i.e. a PRACH transmission on a LTM candidate cell), etc.) is not applied (or not indicated or not performed) on dormant BWP, in order to ease UE implementation. The dormant BWP is one of downlink BWPs configured by the network via dedicated RRC signalling. In the dormant BWP, the UE stops monitoring PDCCH on/for the SCell, but continues performing CSI measurements, Automatic Gain Control (AGC) and beam management, if configured. For each serving cell other than the SpCell or PUCCH SCell or LTM candidate cells, the network may configure one BWP as a dormant BWP. For example, the network does not configure one BWP (e.g. firstActiveDownlinkBWP or initialBWP or defaultBWP) as a dormant BWP for LTM candidate cells. For example, the dormant BWP is one of the UE's dedicated BWPs configured by network via dedicated RRC signalling. The SpCell, PUCCH SCell, and LTM candidate cell cannot be configured with a dormant BWP.

### Completion of Random Access Procedure.

It would be beneficial to have cross-layer interaction between MAC layer and RRC layer to make RRC layer perform RRC-specific behaviors (e.g. stop the supervisor timer for LTM execution procedure). In this reason, the following behaviors are provided:

Upon completion of the Random Access procedure, the MAC entity shall:
1> discard any explicitly signalled contention-free Random Access Resources for 2-step RA type and 4-step RA type except the 4-step RA type contention-free Random Access Resources for beam failure recovery request, if any;
1> flush the HARQ buffer used for transmission of the MAC PDU in the Msg3 buffer and the MSGA buffer.

Upon successful completion of the Random Access procedure initiated for DAPS handover, the target MAC entity shall:
1> indicate the successful completion of the Random Access procedure to the upper layers.

Upon successful completion of the Random Access procedure initiated for LTM execution (or LTM cell switch or LTM execution procedure or by the reception of the first MAC CE), the MAC entity shall:
1> indicate the successful completion of the Random Access procedure (or the LTM execution procedure) to the upper layers.

Upon successful completion of the LTM execution procedure initiated for LTM execution (or LTM cell switch or by the reception of the first MAC CE), the MAC entity shall:
1> indicate the successful completion of the LTM execution procedure to the upper layers.

For RACH-based LTM execution procedure (i.e. LTM execution procedure with Random Access procedure), the UE considers that LTM execution procedure is successfully completed when the RACH is successfully completed.

For RACH-less LTM execution procedure (i.e. LTM execution procedure without Random Access procedure), the UE considers that LTM execution procedure is successfully completed when the UE determines that the network has successfully received its first UL data (e.g. by checking HARQ ACK or RLC ACK for the first UL data or the reception of C-RNTI addressed PDCCH or upon the reception of UE Contention Resolution identify MAC CE)

The following relates to LTM Execution procedure (or LTM command).

In embodiments of this disclosure, TA acquisition of candidate cell(s) before LTM cell switch command is supported as described in Section 2.1.1 and 4.2. By this, as the source cell/DU gets to know the value and the validity of candidate cell TA, it can determine whether it can initiate a RACH-less solution for LTM cell switch and then determine whether it needs to include a beam indication (e.g. TCI state) and TA information in the first MAC CE (i.e. LTM Command MAC CE) as described in Section 4.1. Therefore, the network can indicate a valid TA to the UE or indicate whether a TA is still valid in the first MAC CE. Upon the reception of the TA information indicated in LTM MAC CE, the UE can apply the TA value and start the TA timer for the target LTM candidate cell upon LTM execution (i.e. LTM cell switch) and UE can perform LTM cell switch without Random access procedure (i.e. with RACH-less solution) if TAT for the target LTM candidate cell is running (i.e. TA value is valid) or if Beam failure is not detected for the target LTM candidate cell, which means that UE can monitor PDCCH from the target LTM candidate cell or UE can use configured grants the first UL data transmission to the target cell for RACH-less LTM execution (LTM cell switch). Otherwise, UE can perform LTM execution procedure with Random Access procedure.

To maintain Uplink time alignment efficiently, one of the following options for the behaviors of the MAC entity can be implemented:

RRC configures the following parameters for the maintenance of UL time alignment:

timeAlignmentTimer (per TAG) which controls how long the MAC entity considers the Serving Cells belonging to the associated TAG to be uplink time aligned;
Option 1: In this option, the Timing Advance Command value (or field) is optional (i.e. can be either present or absent) in the first MAC CE (LTM Command MAC CE). Upon the reception of the first MAC CE (LTM Command MAC CE), the corresponding MAC behavior is as follows:

The MAC entity shall:
1> if the MAC entity receives an LTM Command MAC CE on a Serving Cell:
2> indicate to upper layers that the LTM Command MAC CE is received (triggering the LTM cell switch procedure);
2> indicate to upper layers the Target Configuration ID (i.e. identifier for target LTM candidate cell) included in the MAC CE;
2> if Timing Advance Command value is present (or included) or if Timing Advance Command indicates that the Timing Advance value needs to be updated or is not valid anymore or if keeping the Timing Advance or using the TA of the source cell (or Serving cell) is not indicated or if Timing Advance Command value is not set as a special value (e.g. 000 . . . 0 or 111 . . . 1):
3> process the received Timing Advance Command. In another embodiment, UE can process the received Timing Advance Command if Timing Advance Command indicates that the Timing Advance value needs to be updated or is not valid anymore or if keeping the Timing Advance or using the TA of the source cell (or Serving cell) is not indicated, in order to avoid unnecessary processing;
3> when an LTM Command MAC CE including a Timing Advance Command is received (or if Timing Advance Command indicates that the Timing Advance value needs to be updated or is not valid anymore or if keeping the Timing Advance or using the TA of the source cell (or Serving cell) is not indicated):
4> apply the Timing Advance Command for the PTAG or the target LTM candidate cell (or the indicated LTM candidate cell) (i.e. UE can apply and store the Timing Advance value for the PTAG or the target LTM candidate cell);
4> start or restart the timeAlignmentTimer associated with the PTAG or the target LTM candidate cell (or the indicated LTM candidate cell); In another embodiment, UE can start or restart the timeAlignmentTimer associated with the PTAG or the target LTM candidate cell (or the indicated LTM candidate cell) only if the timeAlignmentTimer associated with PTAG or the target LTM candidate cell (or the indicated LTM candidate cell) is not running, in order to avoid unnecessary update procedure.
3> indicate to upper layers to skip the Random Access procedure for this LTM cell switch or the target LTM candidate cell (or the indicated LTM candidate cell). In another embodiment, UE can indicate to upper layers to skip the Random Access procedure for this LTM cell switch or the target LTM candidate cell (or the indicated LTM candidate cell) if timeAlignmentTimer (TAT) for the target/indicated LTM candidate cell (or PTAG) is running (i.e. TA value is valid) or if Beam failure is not detected for the target LTM candidate cell (i.e. if BFI_COUNTER<beamFailureInstanceMaxCount for the target/indicated LTM candidate cell (the number of Beam failure Indication is smaller than the maximum number for beam failure detection).
2> else (if Timing Advance Command value is absent (or not included) or if keeping the Timing Advance or using the TA of the source cell (or Serving cell) is indicated or if Timing Advance Command value is set as a special value (e.g. 000 . . . 0 or 111 . . . 1):
3> indicate to upper layers that a Random Access Procedure is needed for this LTM cell switch or the target LTM candidate cell (or the indicated LTM candidate cell) or indicate to upper layers to trigger the Random Access procedure for this LTM cell switch or the target LTM candidate cell (or the indicated LTM candidate cell); In another embodiment, UE can indicate to upper layers that a Random Access Procedure is needed for this LTM cell switch or the target LTM candidate cell (or the indicated LTM candidate cell) if timeAlignmentTimer (TAT) for the target/indicated LTM candidate cell (or PTAG) is not running (i.e. TA value is not valid) or if Beam failure is detected for the target/indicated LTM candidate cell (i.e. if BFI_COUNTER>=beamFailureInstanceMaxCount for the target/indicated LTM candidate cell (or PTAG) (the number of Beam failure Indication is larger than or equal to the maximum number for beam failure detection).
3> UE can ignore the received Timing Advance Command in order to avoid unnecessary update procedure.
2> if TCI state information is included:
3> consider the SSB corresponding to the indicated TCI state as the selected SSB for the initial uplink transmission towards the candidate cell;
3> indicate to lower layers the information regarding the TCI state information included in the LTM Command MAC CE.
Option 2: In this option, the Timing Advance Command value (or field) is always present in the first MAC CE (LTM Command MAC CE). Upon the reception of the first MAC CE (LTM Command MAC CE), the corresponding MAC behavior is as follows:

The MAC entity shall:
1> if the MAC entity receives an LTM Command MAC CE on a Serving Cell:
2> indicate to upper layers that the LTM Command MAC CE is received (triggering the LTM cell switch procedure);
2> indicate to upper layers the Target Configuration ID (i.e. identifier for target LTM candidate cell) included in the MAC CE;
2> if Timing Advance Command value is not set as a special value (e.g. 000 . . . 0 or 111 . . . 1) or if Timing Advance Command indicates that the Timing Advance value needs to be updated or is not valid anymore:
3> process the received Timing Advance Command;
3> when an LTM Command MAC CE including a Timing Advance Command is received:
4> apply the Timing Advance Command for the PTAG or the target LTM candidate cell (or the indicated LTM candidate cell) (i.e. UE can apply and store the Timing Advance value for the PTAG or the target LTM candidate cell);
4> start or restart the timeAlignmentTimer associated with the PTAG or the target LTM candidate cell (or the indicated LTM candidate cell); In another embodiment, UE can start or restart the timeAlignmentTimer associated with the PTAG or the target LTM candidate cell (or the indicated LTM candidate cell) only if the timeAlignmentTimer associated with PTAG or the target LTM candidate cell (or the indicated LTM candidate cell) is not running, in order to avoid unnecessary update procedure.
3> indicate to upper layers to skip the Random Access procedure for this LTM cell switch or the target LTM candidate cell (or the indicated LTM candidate cell). In another embodiment, UE can indicate to upper layers to skip the Random Access procedure for this LTM cell switch or the target LTM candidate cell (or the indicated LTM candidate cell) if timeAlignmentTimer (TAT) for the target/indicated LTM candidate cell (or PTAG) is running (i.e. TA value is valid) or if Beam failure is not detected for the target LTM candidate cell (i.e. if BFI_COUNTER<beamFailureInstanceMaxCount for the target/indicated LTM candidate cell (the number of Beam failure Indication is smaller than the maximum number for beam failure detection).
2> else (if Timing Advance Command value is set as a special value (e.g. 000 . . . 0 or 111 . . . 1)):
3> indicate to upper layers that a Random Access Procedure is needed for this LTM cell switch or the target LTM candidate cell (or the indicated LTM candidate cell) or indicate to upper layers to trigger the Random Access procedure for this LTM cell switch or the target LTM candidate cell (or the indicated LTM candidate cell); In another embodiment, UE can indicate to upper layers that a Random Access Procedure is needed for this LTM cell switch or the target LTM candidate cell (or the indicated LTM candidate cell) if timeAlignmentTimer (TAT) for the target/indicated LTM candidate cell (or PTAG) is not running (i.e. TA value is not valid) or if Beam failure is detected for the target/indicated LTM candidate cell (i.e. if BFI_COUNTER>=beamFailureInstanceMaxCount for the target/indicated LTM candidate cell (or PTAG) (the number of Beam failure Indication is larger than or equal to the maximum number for beam failure detection).
3> UE can ignore the received Timing Advance Command in order to avoid unnecessary update procedure.
2> if TCI state information is included:
3> consider the SSB corresponding to the indicated TCI state as the selected SSB for the initial uplink transmission towards the candidate cell;
3> indicate to lower layers the information regarding the TCI state information included in the LTM Command MAC CE.

The network may activate and deactivate the TCI states of LTM candidate cell(s) configured in RRC configuration by sending the fourth MAC CE (i.e. LTM Candidate Cell TCI States Activation/Deactivation MAC CE described in Section 4.1) To enable this, several options are provided to activate and deactivate the TCI states upon LTM execution and one of the options can be implemented:
Option 1: In this option, we can restrict the transmission for the fourth MAC CE to the transmission together with the first MAC CE (LTM Command MAC CE described in Section 4.1). For example, the network can send the fourth MAC CE together with the first MAC CE (i.e. both MAC CEs can be included in the same MAC PDU) to activate and deactivate the TCI states for LTM cell switch. If the MAC entity receives a Candidate Cell TCI States Activation/Deactivation MAC CE on a Serving Cell, it indicates to lower layers (i.e. Physical (PHY) layer)) the information regarding the Candidate Cell TCI States Activation/Deactivation MAC CE for the indicated LTM candidate cell from the first MAC CE. If the fourth MAC CE is not received (e.g. with the first MAC CE), the MAC entity indicates to the lower layers the usage of the indicated (or configured) TCI by RRCReconfiguration for the indicated LTM candidate cell from the first MAC CE, or the lower layers uses the indicated (or configured) TCI by RRCReconfiguration for the indicated LTM candidate cell from the first MAC CE.
Option 2: In this option, we do not restrict the transmission for the fourth MAC CE, i.e. the network can send the fourth MAC CE before the transmission of the first MAC CE or regardless of the transmission of the first MAC CE (LTM Command MAC CE described in Section 4.1), in order to activate and deactivate the TCI states for LTM cell switch . . . . However, even if the MAC entity receives a Candidate Cell TCI States Activation/Deactivation MAC CE on a Serving Cell, it indicates to lower layers (i.e. PHY layer (Physical layer)) the information regarding the Candidate Cell TCI States Activation/Deactivation MAC CE for the indicated LTM candidate cell from the first MAC CE upon the reception of the first MAC CE or upon LTM execution. If the fourth MAC CE was not received, the MAC entity indicates to the lower layers the usage of the indicated (or configured) TCI by RRCReconfiguration for the indicated LTM candidate cell from the first MAC CE or the lower layers uses the indicated (or configured) TCI by RRCReconfiguration for the indicated LTM candidate cell from the first MAC CE upon the reception of the first MAC CE or upon LTM execution.

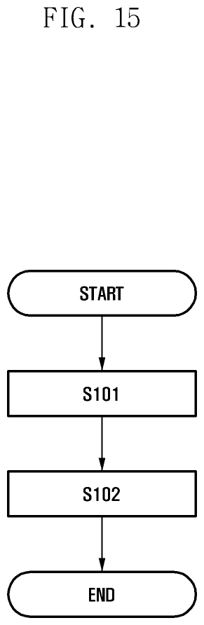

For the sake of completeness, FIG. 15 shows a flowchart illustrating a method according to an embodiment of the disclosure.

Operation S101 is the UE beginning an LTM cell switch. Operation S102 represents a Timing Advance Command (TAC) is present in a first MAC Control Element, CE, arranged to instruct the LTM cell switch.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
receiving, from a base station, a radio resource control (RRC) message including layer 1 (L1)/layer 2 (L2) triggered mobility (LTM) configuration information, the LTM configuration information including at least one LTM candidate configuration for at least one candidate cell;
transmitting, to the base station, a report for an L1 measurement on the at least one candidate cell;
receiving, from the base station via a medium access control (MAC) control element (CE), an LTM cell switch command based on the report;
identifying whether a value of a timing advance command (TAC) in the MAC CE is set to a specific value; and
in case that the value of the TAC is not set to the specific value, processing the TAC and performing a random access channel (RACH)-less LTM cell switch for a target cell identified by the MAC CE.

2. The method of claim 1, further comprising:
in case that the value for the TAC is set to the specific value, performing a random access procedure with the target cell for the LTM cell switch.

3. The method of claim 1,
wherein the MAC CE further includes information indicating an identity of a target configuration corresponding to the target cell and information for activating a transmission configuration indicator (TCI) state for the target cell, and
wherein the performing of the RACH-less LTM cell switch comprises switching to the target cell and applying the target configuration corresponding to the target cell.

4. The method of claim 1, further comprising:
receiving, from the base station, a physical downlink control channel (PDCCH) order to trigger a contention-free random access (CFRA); and
performing a random access preamble transmission for the CFRA to the target cell, before a reception of the MAC CE,
wherein the value of the TAC is determined based on the random access preamble transmission.

5. The method of claim 1, further comprising:
delivering, from a MAC entity to an upper layer, an indication that an LTM cell switch procedure is triggered based on a reception of the MAC CE; and
starting a timer based on the indication,
wherein the timer is stopped, in case that the LTM cell switch procedure is successfully completed.

6. The method of claim 5,
identifying that the timer expires; and
initiating an RRC re-establishment procedure, in case that the timer is for a master cell group (MCG).

7. The method of claim 5,
identifying that the timer expires; and
transmitting, to the base station, a secondary cell group (SCG) failure information, in case that the timer is for an SCG.

8. A terminal in a wireless communication system, the terminal comprising:
a transceiver; and
a controller coupled with the transceiver and configured to:
control the transceiver to receive, from a base station, a radio resource control (RRC) message including layer 1 (L1)/layer 2 (L2) triggered mobility (LTM) configuration information, the LTM configuration information including at least one LTM candidate configuration for at least one candidate cell,
control the transceiver to transmit, to the base station, a report for an L1 measurement on the at least one candidate cell,
control the transceiver to receive, from the base station via a medium access control (MAC) control element (CE), an LTM cell switch command based on the report,
identify whether a value of a timing advance command (TAC) in the MAC CE is set to a specific value, and
in case that the value of the TAC is not set to the specific value, process the TAC and perform a random access channel (RACH)-less LTM cell switch for a target cell identified by the MAC CE.

9. The terminal of claim 8, wherein, in case that the value for the TAC is set to the specific value, the controller is further configured to perform a random access procedure with the target cell for the LTM cell switch.

10. The terminal of claim 8,
wherein the MAC CE further includes information indicating an identity of a target configuration corresponding to the target cell and information for activating a transmission configuration indicator (TCI) state for the target cell, and
wherein for the RACH-less LTM cell switch, the controller is further configured to switch to the target cell and apply the target configuration corresponding to the target cell.

11. The terminal of claim 8,
wherein the controller is further configured to:
control the transceiver to receive, from the base station, a physical downlink control channel (PDCCH) order to trigger a contention-free random access (CFRA), and
perform a random access preamble transmission for the CFRA to the target cell, before a reception of the MAC CE, and
wherein the value of the TAC is determined based on the random access preamble transmission.

12. The terminal of claim 9,
wherein the controller is further configured to:
deliver, from a MAC entity to an upper layer, an indication that an LTM cell switch procedure is triggered based on a reception of the MAC CE, and
start a timer based on the indication, and
wherein the timer is stopped, in case that the LTM cell switch procedure is successfully completed.

13. The terminal of claim 12, wherein the controller is further configured to:
identify that the timer expires; and
initiate an RRC re-establishment procedure, in case that the timer is for a master cell group (MCG).

14. The terminal of claim 12, wherein the controller is further configured to:
identify that the timer expires; and
control the transceiver to transmit, to the base station, a secondary cell group (SCG) failure information, in case that the timer is for an SCG.

15. A method performed by a base station in a wireless communication system, the method comprising:
transmitting, to a terminal, a radio resource control (RRC) message including layer 1 (L1)/layer 2 (L2) triggered mobility (LTM) configuration information, the LTM configuration information including at least one LTM candidate configuration for at least one candidate cell;
receiving, from the terminal, a report for an L1 measurement on the at least one candidate cell; and
transmitting, to a terminal, a medium access control (MAC) control element (CE) including an LTM cell switch command based on the report;
wherein the MAC CE includes a value of a timing advance command (TAC), and
wherein the value of the TAC is used for performing a random access channel (RACH)-less LTM cell switch for a target cell identified by the MAC CE based on processing of the TAC in case that the value of the TAC is not set to a specific value.

16. The method of claim 15, wherein the value of the TAC is used for performing a random access procedure with the target cell for the LTM cell switch in case that the value for the TAC is set to the specific value.

17. The method of claim 15,
wherein the MAC CE further includes information indicating an identity of a target configuration corresponding to the target cell and information for activating a transmission configuration indicator (TCI) state for the target cell, and
wherein the performing of the RACH-less LTM cell switch comprises switching to the target cell and applying the target configuration corresponding to the target cell.

18. A base station in a wireless communication system, the base station comprising:
a transceiver; and
a controller coupled with the transceiver and configured to:
control the transceiver to transmit, to a terminal, a radio resource control (RRC) message including layer 1 (L1)/layer 2 (L2) triggered mobility (LTM) configuration information, the LTM configuration information including at least one LTM candidate configuration for at least one candidate cell,
control the transceiver to receive, from the terminal, a report for an L1 measurement on the at least one candidate cell, and
control the transceiver to transmit, to a terminal, a medium access control (MAC) control element (CE) including an LTM cell switch command based on the report,
wherein the MAC CE includes a value of a timing advance command (TAC), and
wherein the value of the TAC is used for performing a random access channel (RACH)-less LTM cell switch for a target cell identified by the MAC CE based on processing of the TAC in case that the value of the TAC is not set to a specific value.

19. The base station of claim 18, wherein the value of the TAC is used for performing a random access procedure with the target cell for the LTM cell switch in case that the value for the TAC is set to the specific value.

20. The base station of claim 18,
wherein the MAC CE further includes information indicating an identity of a target configuration corresponding to the target cell and information for activating a transmission configuration indicator (TCI) state for the target cell, and
wherein the performing of the RACH-less LTM cell switch comprises switching to the target cell and applying the target configuration corresponding to the target cell.
